(19) United States
(12) Patent Application Publication
(10) Pub. No.: US 2016/0242182 A1
(43) Pub. Date: Aug. 18, 2016

(54) TECHNIQUES FOR SELECTING UPLINK TRANSMIT ANTENNA IN MULTIPLE CONNECTIVITY WIRELESS COMMUNICATIONS

(71) Applicant: QUALCOMM Incorporated, San Diego, CA (US)

(72) Inventors: Wanshi CHEN, San Diego, CA (US); Peter Gaal, San Diego, CA (US); Hao Xu, San Diego, CA (US)

(21) Appl. No.: 15/014,960

(22) Filed: Feb. 3, 2016

Related U.S. Application Data
(60) Provisional application No. 62/115,629, filed on Feb. 12, 2015.

(51) Int. Cl. H04W 72/04; H04B 7/04

(52) U.S. Cl. CPC H04W 72/0453; H04W 72/0413; H04B 7/04

(57) ABSTRACT

Certain aspects of the present disclosure relate to selecting one or more antenna ports for wireless communications. A first communication link can be established over at least a first carrier with at least a first cell of a first cell group. A second communication link can be established over at least a second carrier with at least a second cell of a second cell group. First antenna selection information can be received from the at least first cell of the first cell group, wherein the first antenna selection information relates to a first interval during which to select a first antenna. A second antenna to utilize in communicating over the second communication link during the first interval can be determined based at least in part on the first antenna selection information.

### CLAIM OF PRIORITY UNDER 35 U.S.C. §119

The present application for patent claims priority to Provisional Application No. 62/115,629 entitled “TECHNIQUES FOR SELECTING UPLINK TRANSMIT ANTENNA IN MULTIPLE CONNECTIVITY WIRELESS COMMUNICATIONS” filed Feb. 12, 2015, which is assigned to the assignee hereof and hereby expressly incorporated by reference herein in its entirety.

### FIELD OF THE DISCLOSURE

The present disclosure, for example, relates to wireless communication systems, and more particularly to techniques for selecting uplink transmit antenna in multiple connectivity wireless communications.

### BACKGROUND OF THE DISCLOSURE

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations (e.g., eNodeBs) that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

In carrier aggregation, the UE can be configured to communicate with a cell over multiple component carriers to facilitate improved data throughput, diversity, reliability, etc. One of the multiple component carriers is assigned as a primary component carrier, over which control data is communicated for the primary component carrier and any other secondary component carriers, which may include control information to activate/deactivate the secondary component carriers.

In multiple connectivity, the UE can be configured to communicate with multiple cells or cell groups configured by multiple base stations using multiple links. Each of the links may be configured with multiple component carriers (e.g., carrier aggregation over one or more of the multiple links with the corresponding cell group). In this configuration, the UE can communicate control data for each link over a primary component carrier configured for the given link.

Third generation partnership project (3GPP) long term evolution (LTE) UEs can support antenna selection to select one or more antennas equipped at a UE to transmit control and/or data channel communications to serving network nodes (e.g., evolved Node Bs (eNB)). Antenna selection may be performed as open loop (e.g., such that the UE can select one or more transmit antennas without assistance) or closed loop (e.g., such that the UE can select one or more transmit antennas based on information related to a network node to receive the communications, such as information relating to a downlink control information (DCI) format 0 received from the network node). For a UE configured with multiple connectivity and closed loop antenna selection, however, it is possible that the UE receives antenna selection information from multiple cells over each cell group that may not be coordinated among the cell groups, and/or may include conflicting information received for time intervals that at least partially overlap in time. This may result in unexpected and undesirable performing of antenna selection at the UE.

### SUMMARY OF THE DISCLOSURE

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for selecting one or more antenna ports for wireless communications is provided. The method may include establishing a first communication link over at least a first carrier with at least a first cell of a first cell group, establishing a second communication link over at least a second carrier with at least a second cell of a second cell group, receiving first antenna selection information from the at least first cell of the first cell group, wherein the first antenna selection information relates to a first interval during which to select a first antenna, and determining, based at least in part on the first antenna selection information, a second to utilize in communicating over the second communication link during the first interval.

In an aspect, the method may further include wherein the first cell group is a primary cell group and the second cell group is a secondary cell group in multiple connectivity. The method may also include wherein determining the second antenna is based at least in part on a configured priority for antenna selection information from the first cell group over the second cell group.

Further, the method may include wherein the first cell group and the second cell group are synchronous in time. The method may also include determining the second antenna is the same as the first antenna during the first interval.

Additionally, the method may include wherein the first cell group and the second cell group are asynchronous in time. The method may also include receiving second antenna selection information from the at least second cell of the second cell group, wherein the second antenna selection information relates to a second interval during which to select the second antenna, and wherein the second interval at least partially overlaps the first interval. Moreover, the method may include determining whether to communicate over the second communication link during the second interval based at least in part on receiving the first antenna selection information and receiving the second antenna selection information.

The method may also include receiving second antenna selection information from the at least first cell of the first cell group, wherein the second antenna selection information relates to a second interval during which to select a third antenna, and wherein the second interval is different from the first interval. Additionally, the method may include determining whether to communicate over the second communication link during the second interval, which overlaps the first interval and the third interval, based at least in part on receiving the first antenna selection information and receiving the second antenna selection information. The method may further include dropping a transmission scheduled over the second communication link based at least in part on determining that one or more antenna ports indicated in the first antenna selection information differ from a different one or more antenna ports indicated in the second antenna selection information.

Also, the method may include communicating a capability indicator to at least one of the at least first cell or the at least second cell. The method may include wherein the capability indicator indicates support of communicating with multiple cells using multiple antenna port configurations, and wherein determining the second antenna comprises determining the second antenna as different from the first antenna. The method may further include wherein the capability indicator indicates no support of communicating with multiple cells using multiple antenna port configurations, and further comprising disabling a closed loop antenna selection.

In another example, an apparatus for selecting one or more antenna ports for wireless communications is provided. The apparatus may include a transceiver, at least one processor communicatively coupled with the transceiver, via a bus, for communicating signals in a wireless network, and a memory communicatively coupled with the at least one processor and/or the transceiver via the bus. The at least one processor is operable to establish a first communication link over at least a first carrier with at least a first cell of a first cell group, establish a second communication link over at least a second carrier with at least a second cell of a second cell group, receive first antenna selection information from the at least first cell of the first cell group, wherein the first antenna selection information relates to a first interval during which to select a first antenna, and determine, based at least in part on the first antenna selection information, a second antenna to utilize in communicating over the second communication link during the first interval.

In an aspect, the apparatus may include wherein the first cell group is a primary cell group and the second cell group is a secondary cell group in multiple connectivity. In another aspect, the apparatus may include wherein the at least one processor is operable to determine the second antenna based at least in part on a configured priority for antenna selection information from the first cell group over the second cell group. Additionally, the apparatus may include wherein the first cell group and the second cell group are synchronous in time. The apparatus may also include wherein the at least one processor is further operable to determine the second antenna is the same as the first antenna during the first interval.

The apparatus may additionally include wherein the first cell group and the second cell group are asynchronous in time. Also, the apparatus may include wherein the at least one processor is further operable to receive second antenna selection information from the at least second cell of the second cell group, wherein the second antenna selection information relates to a second interval during which to select the second antenna, and wherein the second interval at least partially overlaps the first interval. Moreover, the apparatus may include wherein the at least one processor is further operable to determine whether to communicate over the second communication link during the second interval based at least in part on receiving the first antenna selection information and receiving the second antenna selection information. The apparatus may also include wherein the at least one processor is further operable to receive second antenna selection information from the at least first cell of the first cell group, wherein the second antenna selection information relates to a second interval during which to select a third antenna, and wherein the second interval is different from the first interval. Additionally, the apparatus may include wherein the at least one processor is operable to determine whether to communicate over the second communication link during the second interval, which overlaps the first interval and the third interval, based at least in part on receiving the first antenna selection information and receiving the second antenna selection information. The apparatus may further include wherein the at least one processor is further operable to drop a transmission scheduled over the second communication link based at least in part on determining that one or more antenna ports indicated in the first antenna selection information differ from a different one or more antenna ports indicated in the second antenna selection information.

The apparatus may also include wherein the at least one processor is further operable to communicate a capability indicator to at least one of the at least first cell or the at least second cell. The apparatus may include wherein the capability indicator indicates support of communicating with multiple cells using multiple antenna port configurations, and wherein the at least one processor is operable to determine the second antenna at least in part by determining the second antenna as different from the first antenna. Additionally, the apparatus may include wherein the capability indicator indicates no support of communicating with multiple cells using multiple antenna port configurations, and wherein the at least one processor is further operable to disable a closed loop antenna selection.

In another example, an apparatus for selecting one or more antenna ports for wireless communications is provided. The apparatus may include means for establishing a first communication link over at least a first carrier with at least a first cell of a first cell group, means for establishing a second communication link over at least a second carrier with at least a second cell of a second cell group, means for receiving first antenna selection information from the at least first cell of the first cell group, wherein the first antenna selection information relates to a first interval during which to select a first antenna, and means for determining, based at least in part on the first antenna selection information, a second antenna to utilize in communicating over the second communication link during the first interval.

In another aspect, a computer-readable storage medium comprising computer-executable code for selecting one or more antenna ports for wireless communications is provided. The code may include code for establishing a first communication link over at least a first carrier with at least a first cell of a first cell group, code for establishing a second communication link over at least a second carrier with at least a second cell of a second cell group, code for receiving first antenna selection information from the at least first cell of the first cell group, wherein the first antenna selection information relates to a first interval during which to select a first antenna, and code for determining, based at least in part on the first antenna selection information, a second antenna to utilize in communicating over the second communication link during the first interval.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating an example of a wireless communications system, in accordance with various aspects of the present disclosure.

FIG. 2 is a block diagram conceptually illustrating examples of an eNodeB and a UE configured in accordance with various aspects of the present disclosure.

FIG. 3 is a block diagram conceptually illustrating an aggregation of radio access technologies at a UE, in accordance with various aspects of the present disclosure.

FIG. 4 is a block diagram conceptually illustrating an example of data paths between a UE and a PDN, in accordance with various aspects of the present disclosure.

FIG. 5 is a diagram conceptually illustrating multiple connectivity, in accordance with various aspects of the present disclosure.

FIG. 6 is a block diagram conceptually illustrating an example of a UE and components configured in accordance with various aspects of the present disclosure.

FIG. 7 is a flowchart illustrating an example method for performing antenna selection, in accordance with various aspects of the present disclosure.

FIG. 8 illustrates example asynchronous timelines of subframes for multiple cell groups in accordance with various aspects of the present disclosure.

FIG. 9 is a flowchart illustrating an example method for performing antenna selection, in accordance with various aspects of the present disclosure.

FIG. 10 is a flowchart illustrating an example method for performing antenna selection, in accordance with various aspects of the present disclosure.

FIG. 11 is a block diagram conceptually illustrating an example of a network entity and components configured in accordance with various aspects of the present disclosure.

FIG. 12 is a flowchart illustrating an example method for coordinating antenna selection information, in accordance with various aspects of the present disclosure.

FIG. 13 is a flowchart illustrating an example method for coordinating antenna selection information, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various techniques including methods, apparatuses, devices, and systems are described for performing antenna selection at a wireless device for transmitting communications in multiple cell groups in multiple connectivity. In some aspects, a wireless device (e.g., user equipment (UE)) can communicate with one or more cells over one or more component carriers (CC), where the CCs may be configured with at least one network entity (e.g., evolved Node B (eNB)) in carrier aggregation (CA) and/or with multiple network entities in multiple connectivity. In multiple connectivity, it is to be appreciated that the UE may be configured with multiple carriers in CA with one or more of the multiple cells. In some aspects, in multiple connectivity, a wireless device may receive first configuration information to communicate with a first primary cell (e.g., a master cell group (MCG)/primary cell group (PCG) primary cell, also referred to herein as PCell or PCell_{MCG}) of a first network entity. The wireless device may also receive second configuration information to communicate with a second primary cell (e.g., a secondary cell group (SCG) primary cell, also referred to herein as PCell_{SCG}) of a second network entity. In the case of multiple connectivity, the PCells may be configured by different eNodeBs (e.g., a master eNodeB or MeNodeB that provides the PCell_{MCG}, and a secondary eNodeB or SeNodeB that provides the PCell_{SCG}).

In addition, the wireless device may be generally configured to perform antenna selection to select one or more physical or virtual antenna ports coupled to one or more physical antennas of the wireless device to utilize in communicating with multiple cells or cell groups. For example, antenna selection may include closed loop antenna selection assisted by information from one or more cells. It is possible that antenna selection information provided to the wireless device by one cell (e.g., PCell_{MCG}) conflicts with antenna selection information provided by another cell (e.g., PCell_{SCG}) in a given time interval. Accordingly, aspects described herein relate to determining, based on received antenna selection information, which antenna port(s) to use in communicating with the one cell (e.g., PCell_{MCG} and/or related cells in the cell group) and/or the other cell (e.g., PCell_{SCG} and/or related cells in the cell group). In one example, the cells may coordinate antenna selection information in multiple connectivity to ensure conflicting information is not provided to the UE communicating with the cells. In another example, the UE may determine how to prioritize or otherwise process conflicting antenna selection information from multiple cells, etc. It is to be appreciated that aspects described herein can be provided where the cells or cell groups in multiple connectivity are synchronous or asynchronous.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of UMTS. 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

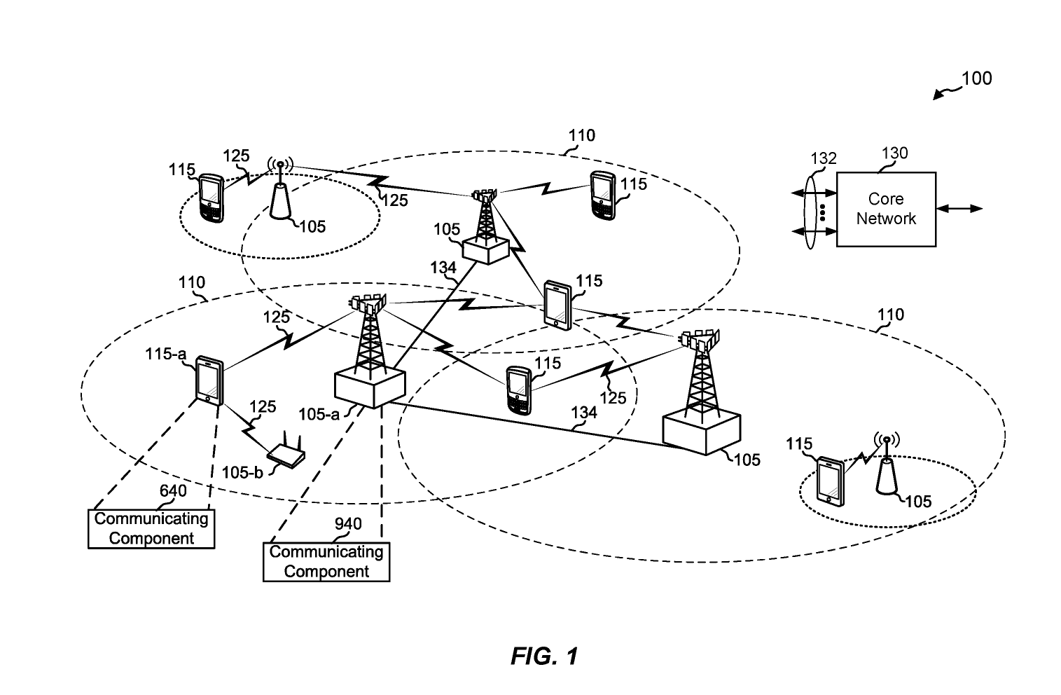

FIG. 1 is a block diagram conceptually illustrating an example of a wireless communications system 100, in accordance with various aspects of the present disclosure. The wireless communications system 100 includes base stations/eNodeBs (or cells) 105, user equipment (UEs) 115, and a core network 130. The eNodeBs 105 may communicate with the UEs 115 under the control of a eNodeB controller (not shown), which may be part of the core network 130 or the eNodeBs 105 in various embodiments. UEs 115 may include a communicating component 640, as described further herein, for determining processing of antenna selection information. Similarly, eNodeBs 105 may include a communicating component 1140, as described further herein, for possibly coordinating antenna selection information.

The eNodeBs 105 may communicate control information and/or user data with the core network 130 through first backhaul links 132. In embodiments, the eNodeBs 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time. In some aspects, the multiple flows may correspond to multiple wireless wide area networks (WWANs) or cellular flows. In other aspects, the multiple flows may correspond to a combination of WWANs or cellular flows and wireless local area networks (WLANs) or Wi-Fi flows.

The eNodeBs 105 may wirelessly communicate with the UEs 115 via one or more eNodeB antennas. Each of the eNodeBs 105 sites may provide communication coverage for a respective geographic coverage area 110. In some embodiments, eNodeBs 105 may be referred to as a base transceiver station, a radio base station, an access point, a radio transceiver, a basic service set (BSS), an extended service set (ESS), a NodeB, eNodeB, Home NodeB, a Home eNodeB, network entity, or some other suitable terminology. The geographic coverage area 110 for a eNodeB 105 may be divided into sectors making up only a portion of the coverage area (not shown). The wireless communications system 100 may include eNodeBs 105 of different types (e.g., macro, micro, and/or pico base stations). There may be overlapping coverage areas for different technologies.

In implementations, the wireless communications system 100 is an LTE/LTE-A network communication system. In LTE/LTE-A network communication systems, the terms evolved Node B (eNodeB) may be generally used to describe the eNodeBs 105. The wireless communications system 100 may be a Heterogeneous LTE/LTE-A network in which different types of eNodeBs provide coverage for various geographical regions. For example, each eNodeB 105 may provide communication coverage for a macro cell, a pico cell, a femto cell, and/or other types of cell. A macro cell may cover a relatively large geographic area (e.g., several kilometers in radius) and may allow unrestricted access by UEs 115 with service subscriptions with the network provider. A pico cell may cover a relatively smaller geographic area (e.g., buildings) and may allow unrestricted access by UEs 115 with service subscriptions with the network provider. A femto cell may cover a relatively small geographic area (e.g., a home) and, in addition to unrestricted access, may also provide restricted access by UEs 115 having an association with the femto cell (e.g., UEs 115 in a closed subscriber group (CSG), UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femto cell may be referred to as a femto eNodeB or a home eNodeB. An eNodeB 105 may support one or multiple (e.g., two, three, four, and the like) cells. The wireless communications system 100 may support use of LTE and WLAN or Wi-Fi by one or more of the UEs 115. Moreover, eNodeB 105 may be a relay, a UE communicating with a UE 115 in a peer-to-peer or ad-hoc mode, etc.

The core network 130 may communicate with the eNodeBs 105 or other eNodeBs 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNodeBs, pico eNodeBs, femto eNodeBs, relays, and the like. Moreover, in an example, UE 115 may include a relay, a pico or femto eNodeB, and/or substantially any device that can receive wireless network access via one or more other devices.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain aspects of the wireless communications system 100, a UE 115 may be configured to support carrier aggregation (CA) or multiple connectivity with two or more cells provided by one or more eNodeBs 105. The eNodeBs 105 that are used for CA/multiple connectivity may be collocated or may be connected through fast connections and/or non-collocated. In either case, coordinating the aggregation of CCs for wireless communications between the UE 115 and the eNodeBs 105 may be carried out more easily because information can be readily shared between the various cells being used to perform the carrier aggregation. When the eNodeBs 105 that are used for carrier aggregation are non-collocated (e.g., far apart or do not have a high-speed connection between them), which can also include when eNodeBs 105 have a non-ideal backhaul (e.g., where latency over the backhaul link may prevent synchronizing the eNodeBs), then coordinating the aggregation of component carriers may involve additional aspects.

For example, in carrier aggregation for dual connectivity (e.g., UE 115 connected to two non-collocated eNodeBs 105), the UE 115 may receive configuration information to communicate with a first eNodeB 105 (e.g., secondary eNodeB (SeNodeB or SeNB)) through a primary cell of the first eNodeB 105. The first eNodeB 105 may include a group of cells referred to as a secondary cell group or SCG, which includes one or more secondary cells and the primary cell or PCell_{SCG} of the first eNodeB 105. The UE 115 may also receive configuration information to communicate with a second eNodeB 105 (e.g., master eNodeB (MeNodeB or MeNB)) through a second primary cell of the second eNodeB 105. The second eNodeB 105 may include a group of cells referred to as a master cell group or MCG, which includes one or more secondary cells and the primary cell or PCell_{MCG} of the second eNodeB 105.

In certain aspects of the wireless communications system 100, carrier aggregation for dual connectivity may involve having a secondary eNodeB 105 (e.g., SeNodeB or SeNB) be configured to operate one of its cells as a PCell_{SCG}. The secondary eNodeB 105 may transmit, to a UE 115, configuration information through the PCell_{SCG} for the UE 115 to communicate with the secondary eNodeB 105 while the UE 115 is in communication with a master eNodeB 105 (e.g., MeNodeB or MeNB). Similarly, the UE 115 may transmit uplink control information for the SCG to the PCell_{SCG}. The master eNodeB 105 may transmit, to the same UE 115, configuration information via its PCell for that UE 115 to communicate with the other eNodeB 105. Similarly, the UE 115 may transmit uplink control information for the MCG to the PCell. The two eNodeBs 105 may be non-collocated.

In examples described herein, UE 115 can include a communicating component 640 configured to process antenna selection information received from one or more cells or cell groups to determine which antenna(s) to use in communicating with the one or more cells or cell groups and/or additional cells or cell groups in multiple connectivity. For example, the UE 115 may perform antenna selection for each of the multiple cells if supported. In another example, the UE 115 may determine whether to perform antenna selection for one or another cell where conflicting antenna selection information is received for a specific time period. In addition, for example, eNodeB 105 may include a communicating component 1140 configured to coordinate antenna selection information for providing the UE 115 to prevent the UE 115 receiving conflicting information.

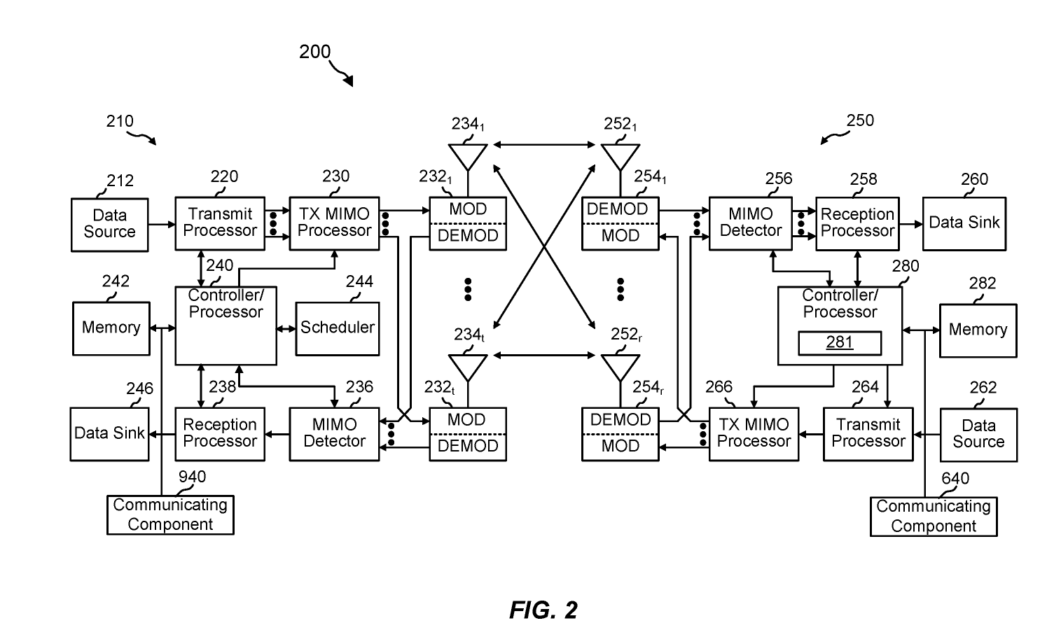

FIG. 2 is a block diagram conceptually illustrating examples of an eNodeB 210 and a UE 250 configured in accordance with an aspect of the present disclosure. For example, the base station/eNodeB 210 and the UE 250 of a system 200, as shown in FIG. 2, may be one of the base stations/eNodeBs and one of the UEs in FIG. 1, respectively. In some aspects, the eNodeB 210 may support multiple connectivity (e.g., dual connectivity), carrier aggregation, etc. The eNodeB 210 may be an MeNodeB or MeNB having one of the cells in its MCG configured as a PCell_{MCG} or an SeNodeB or SeNB having one of its cells in its SCG configured as a PCell_{SCG}. In some aspects, the UE 250 may also support multiple connectivity carrier aggregation. The UE 250 may receive configuration information from the eNodeB 210 via the PCell_{MCG} and/or the PCell_{SCG}. The eNodeBs 210 may be equipped with antennas 234₁₋ₜ, and the UE 250 may be equipped with antennas 252₁₋ᵣ, wherein t and r are integers greater than or equal to one. Moreover, the eNodeB 210 can include a communicating component 1140 for possibly coordinating antenna selection information with other eNodeBs or related cells in one or more cell groups, and UE 250 may include a communicating component 640 for determining processing of antenna selection information for multiple cell groups in multiple connectivity.

At the eNodeB 210, a eNodeB transmit processor 220 may receive data from a eNodeB data source 212 and control information from a eNodeB controller/processor 240. The control information may be carried on the PBCH, PCFICH, physical hybrid automatic repeat/request (HARQ) indicator channel (PHICH), PDCCH, etc. The data may be carried on the PDSCH, etc. The eNodeB transmit processor 220 may process (e.g., encode and symbol map) the data and control information to obtain data symbols and control symbols, respectively. The eNodeB transmit processor 220 may also generate reference symbols, e.g., for the PSS, SSS, and cell-specific reference signal (RS). A eNodeB transmit (TX) multiple-input multiple-output (MIMO) processor 230 may perform spatial processing (e.g., precoding) on the data symbols, the control symbols, and/or the reference symbols, if applicable, and may provide output symbol streams to the eNodeB modulators/demodulators (MODs/DEMODs) 232₁₋ₜ. Each eNodeB modulator/demodulator 232 may process a respective output symbol stream (e.g., for OFDM, etc.) to obtain an output sample stream. Each eNodeB modulator/demodulator 232 may further process (e.g., convert to analog, amplify, filter, and upconvert) the output sample stream to obtain a downlink signal. Downlink signals from modulators/demodulators 232₁₋ₜ may be transmitted via the antennas 234₁₋ₜ, respectively.

At the UE 250, the UE antennas 252₁₋ᵣ may receive the downlink signals from the eNodeB 210 and may provide received signals to the UE modulators/demodulators (MODs/DEMODs) 254₁₋ᵣ respectively. Each UE modulator/demodulator 254 may condition (e.g., filter, amplify, downconvert, and digitize) a respective received signal to obtain input samples. Each UE modulator/demodulator 254 may further process the input samples (e.g., for OFDM, etc.) to obtain received symbols. A UE MIMO detector 256 may obtain received symbols from all the UE modulators/demodulators 254₁₋ᵣ, and perform MIMO detection on the received symbols if applicable, and provide detected symbols. A UE reception processor 258 may process (e.g., demodulate, deinterleave, and decode) the detected symbols, provide decoded data for the UE 250 to a UE data sink 260, and provide decoded control information to a UE controller/processor 280.

On the uplink, at the UE 250, a UE transmit processor 264 may receive and process data (e.g., for the physical uplink shared channel (PUSCH)) from a UE data source 262 and control information (e.g., for the physical uplink control channel (PUCCH)) from the UE controller/processor 280. The UE transmit processor 264 may also generate reference symbols for a reference signal. The symbols from the UE transmit processor 264 may be precoded by a UE TX MIMO processor 266 if applicable, further processed by the UE modulator/demodulators 254₁, (e.g., for SC-FDM, etc.), and transmitted to the eNodeB 210. At the eNodeB 210, the uplink signals from the UE 250 may be received by the eNodeB antennas 234, processed by the eNodeB modulators/demodulators 232, detected by a eNodeB MIMO detector 236 if applicable, and further processed by a eNodeB reception processor 238 to obtain decoded data and control information sent by the UE 250. The eNodeB reception processor 238 may provide the decoded data to a eNodeB data sink 246 and the decoded control information to the eNodeB controller/processor 240.

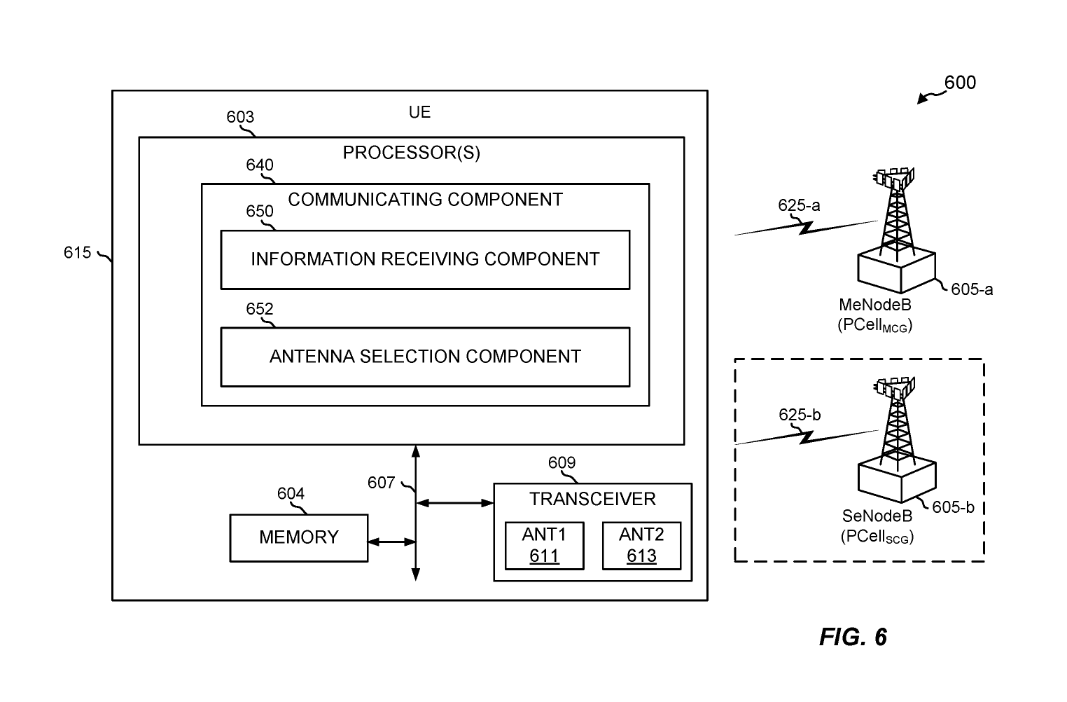

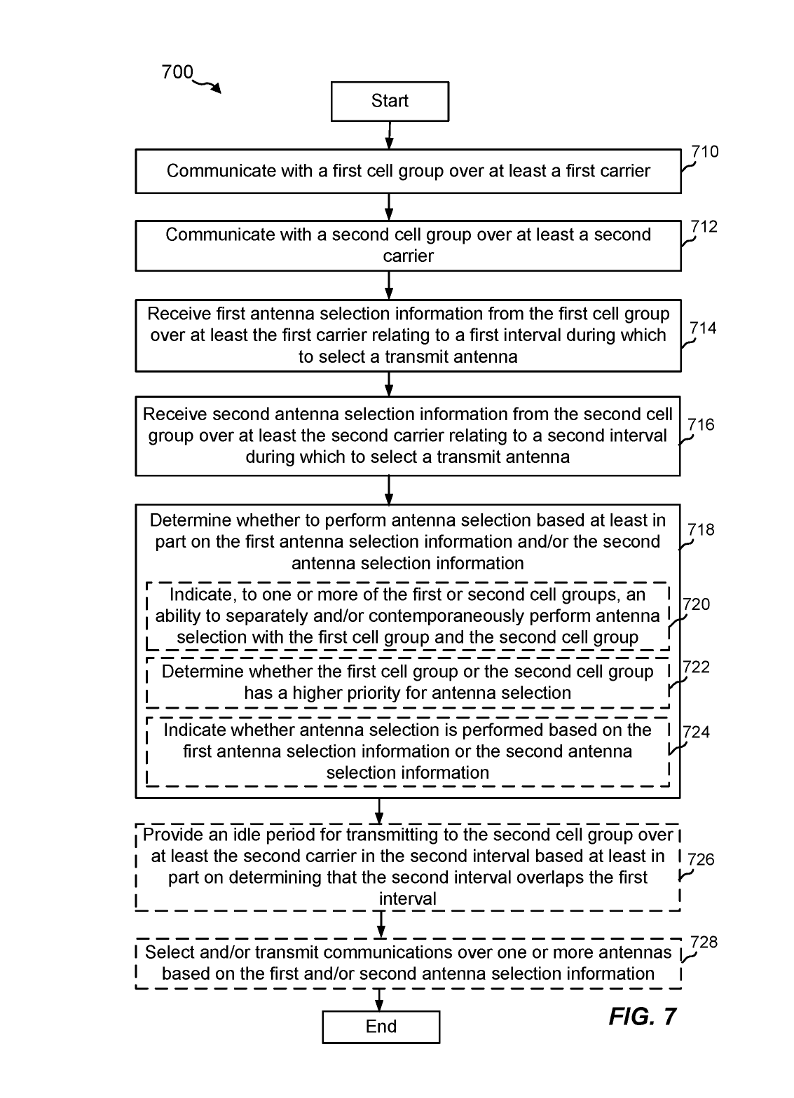

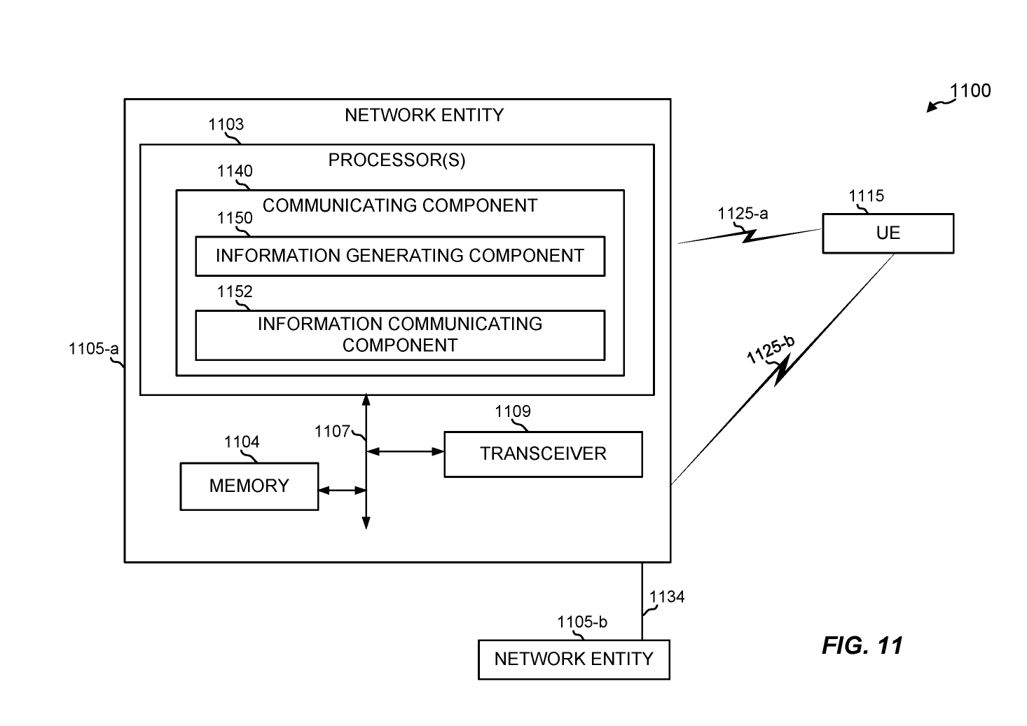

The eNodeB controller/processor 240 and the UE controller/processor 280 may direct the operation at the eNodeB 210 and the UE 250, respectively. The UE controller/processor 280 and/or other processors and modules at the UE 250 may also perform or direct, e.g., the execution of the functional blocks illustrated in FIGS. 6, 11, etc. and/or other processes for the techniques described herein (e.g., flowcharts illustrated in FIGS. 7, 9, 10, 12, 13, etc.). In some aspects, at least a portion of the execution of these functional blocks and/or processes may be performed by block 281 in the UE controller/processor 280. The eNodeB memory 242 and the UE memory 282 may store data and program codes for the eNodeB 210 and the UE 250, respectively. For example, the UE memory 282 may store configuration information for multiple connectivity provided by the eNodeB 210 and/or another eNodeB. A scheduler 244 may be used to schedule UE 250 for data transmission on the downlink and/or uplink.

In one configuration, the UE 250 may include means for establishing a first communication link over at least a first carrier with at least a first cell of a first cell group, means for establishing a second communication link over at least a second carrier with at least a second cell of a second cell group, means for receiving first antenna selection information from the at least first cell of the first cell group, wherein the first antenna selection information relates to a first interval during which to select a first antenna, and means for determining, based at least in part on the first antenna selection information, a second antenna to utilize in communicating over the second communication link during the first interval. In one aspect, the aforementioned means may be or may include the UE controller/processor 280, the UE memory 282, the UE reception processor 258, the UE MIMO detector 256, the UE modulators/demodulators 254, and/or the UE antennas 252 configured to perform the functions recited by the aforementioned means. In another aspect, the aforementioned means may be a module, component, or any apparatus configured to perform the functions recited by the aforementioned means. Examples of such modules, components, or apparatus may be described with respect to FIG. 6 and/or functions performed in the Blocks of FIGS. 7, 9, 10, etc.

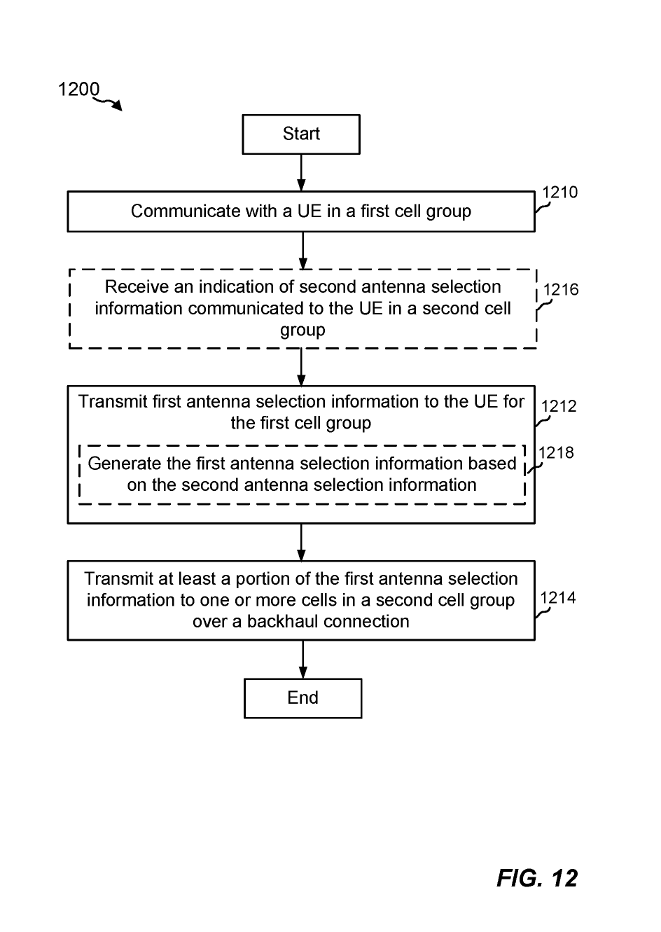

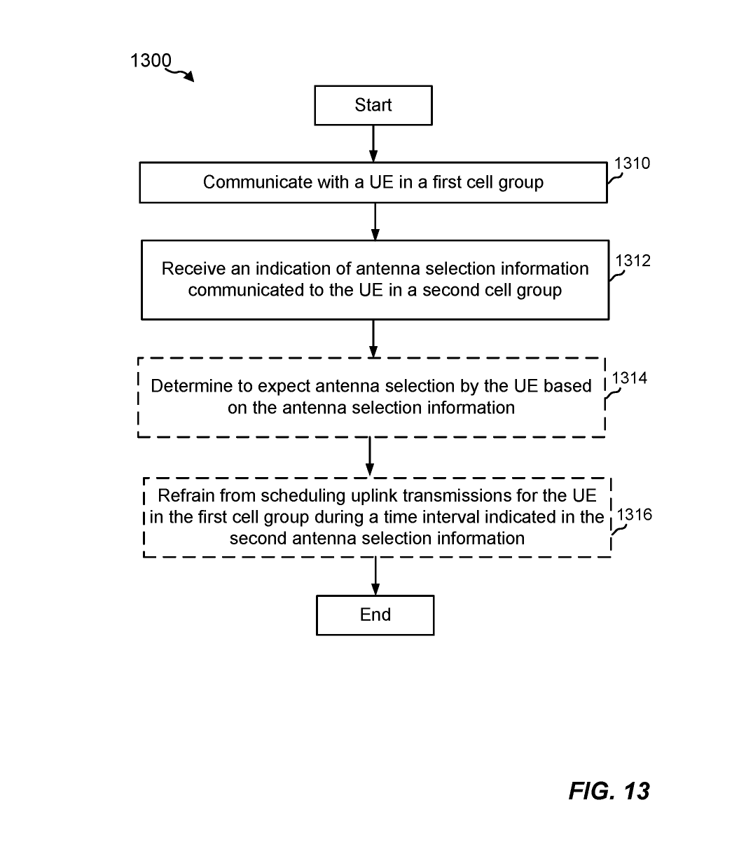

In one configuration, the eNodeB 210 may include means for communicating with a user equipment (UE) in a first cell group, means for transmitting first antenna selection information to the UE for the first cell group, and/or means for communicating at least a portion of the first antenna selection information to one or more cells in a second cell group over a backhaul connection. In one aspect, the aforementioned means may be or may include the controller/processor 240, the memory 242, the reception processor 238, the MIMO detector 236, the modulators/demodulators 232, and/or the antennas 234 configured to perform the functions recited by the aforementioned means. In another aspect, the aforementioned means may be a module, component, or any apparatus configured to perform the functions recited by the aforementioned means. Examples of such modules, components, or apparatus may be described with respect to FIG. 11 and/or functions performed in the Blocks of FIGS. 12, 13, etc.

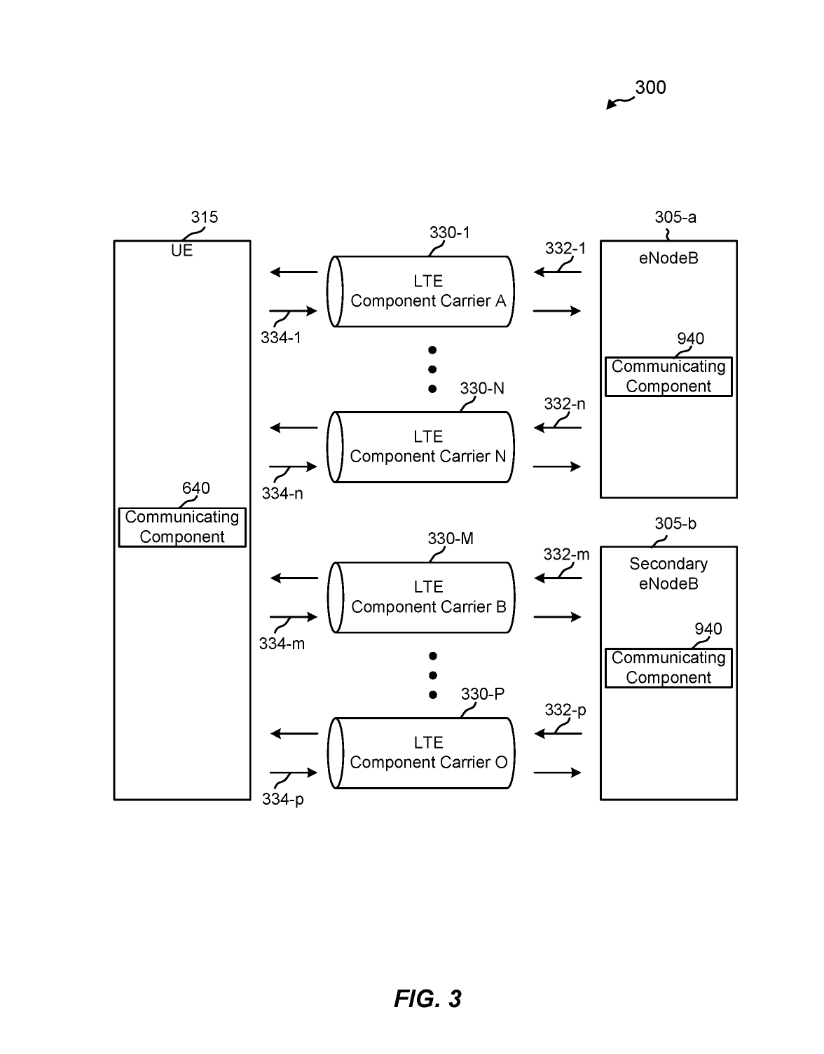

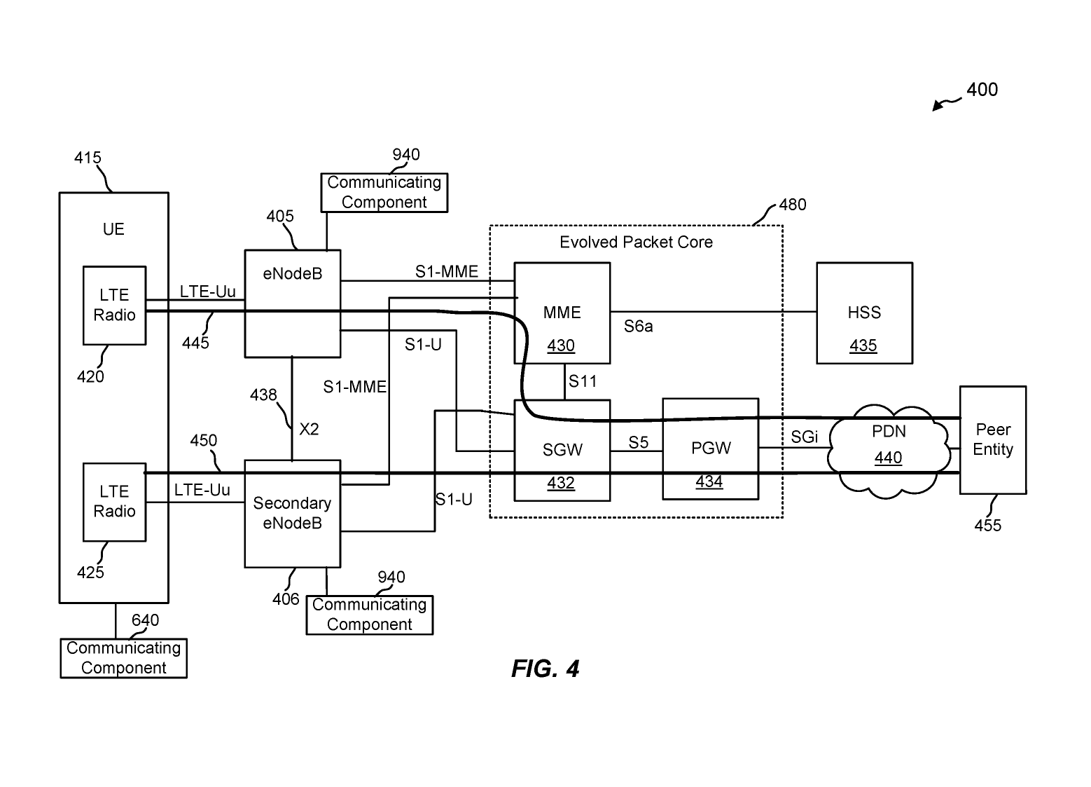

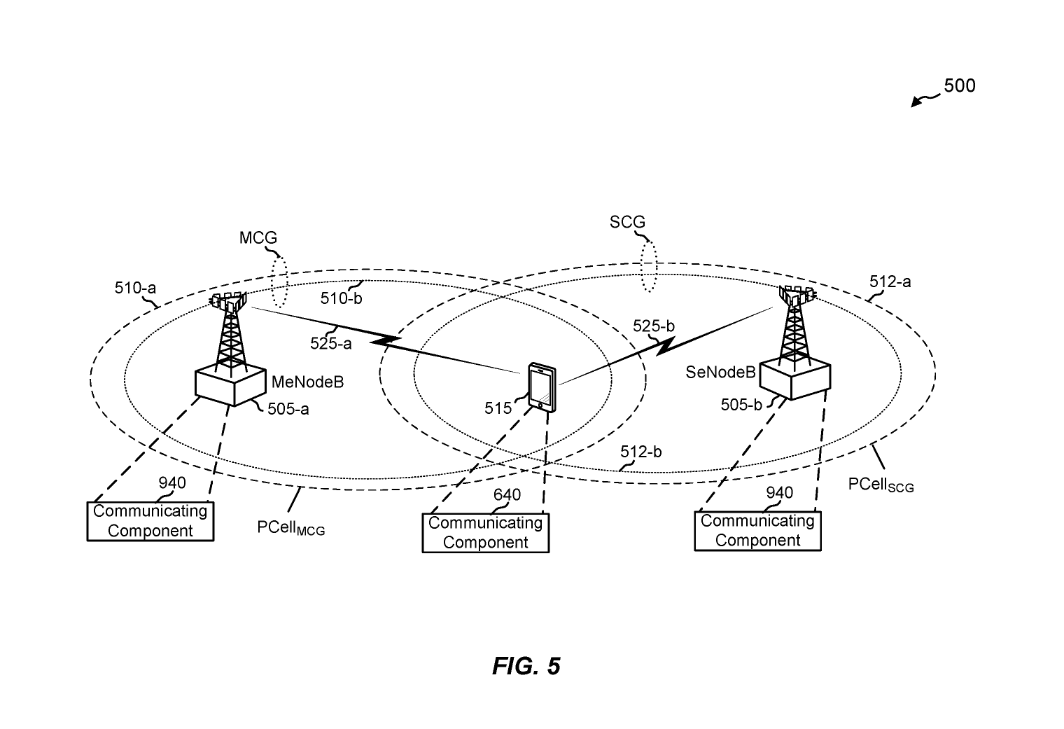

FIG. 3 is a block diagram conceptually illustrating an aggregation of carriers and/or connections at a UE, in accordance with an aspect of the present disclosure. The aggregation may occur in a system 300 including a multi-mode UE 315, which can communicate with an eNodeB 305-a using one or more component carriers 1 through N (CC₁-CC_{N}), and/or with a secondary eNodeB 305-b using one or more component carriers M through P (CC_{M}-CC_{P}). For example, the eNodeB 305-a and/or secondary eNodeB 305-b may include an AP, femto cell, pico cell, etc. eNodeB 305-a and/or secondary eNodeB 305-b may include a communicating component 1140 for possibly coordinating antenna selection information with other eNodeBs/APs or related cells in one or more cell groups, and UE 315 may include a communicating component 640 for determining processing of antenna selection information for selecting an antenna for communicating with one or more of the multiple cell groups in multiple connectivity. A multi-mode UE in this example may refer to a UE that supports more than one radio access technology (RAT). For example, the UE 315 may support at least a WWAN radio access technology (e.g., LTE) and/or a WLAN radio access technology (e.g., WiFi). A multi-mode UE may also support multiple connectivity carrier aggregation as described herein. The UE 315 may be an example of one of the UEs of FIG. 1, FIG. 2, FIG. 3, FIG. 4, FIG. 5, FIG. 6, FIG. 11. The eNodeB 305-a and/or secondary eNodeB 305-b may be an example of one of the eNodeBs, base stations, network entities, etc. of FIG. 1, FIG. 2, FIG. 3, FIG. 4, FIG. 5, FIG. 6, FIG. 11. While only one UE 315, one eNodeB 305-a, and one secondary eNodeB 305-b are illustrated in FIG. 3, it will be appreciated that the system 300 can include any number of UEs 315, eNodeBs 305-a, and/or secondary eNodeBs 305-b. In one specific example, UE 315 can communicate with one eNodeB 305-a over one or more LTE component carriers 330-1 to 330-N while communicating with another eNodeB 305-b over another one or more component carriers 330-M to 330-P.

The eNodeB 305-a can transmit information to the UE 315 over forward (downlink) channels 332-1 through 332-N on LTE component carriers CC₁ through CC_{N} 330. In addition, the UE 315 can transmit information to the eNodeB 305-a over reverse (uplink) channels 334-1 through 334-N on LTE component carriers CC₁ through CC_{N}. Similarly, the eNodeB 305-b can transmit information to the UE 315 over forward (downlink) channels 332-m through 332-p on LTE component carriers CC_{M} through CC_{P} 330. In addition, the UE 315 can transmit information to the eNodeB 305-b over reverse (uplink) channels 334-m through 334-p on LTE component carriers CC_{M} through CC_{P}.

In describing the various entities of FIG. 3, as well as other figures associated with some of the disclosed embodiments, for the purposes of explanation, the nomenclature associated with a 3GPP LTE or LTE-A wireless network is used. However, it is to be appreciated that the system 300 can operate in other networks such as, but not limited to, an OFDMA wireless network, a CDMA network, a 3GPP2 CDMA2000 network and the like.

In multi-carrier operations, the downlink control information (DCI) messages associated with different UEs 315 can be carried on multiple component carriers. For example, the DCI on a PDCCH can be included on the same component carrier that is configured to be used by a UE 315 for physical downlink shared channel (PDSCH) transmissions (i.e., same-carrier signaling). Alternatively, or additionally, the DCI may be carried on a component carrier different from the target component carrier used for PDSCH transmissions (i.e., cross-carrier signaling). In some implementations, a carrier indicator field (CIF), which may be semi-statically enabled, may be included in some or all DCI formats to facilitate the transmission of PDCCH control signaling from a carrier other than the target carrier for PDSCH transmissions (cross-carrier signaling). Similarly, uplink control information (UCI) messages from a UE 315 can be transmitted using a control channel (e.g., PUCCH) carried on one of the CCs configured as a primary CC, or on a data channel (e.g., PUSCH) carried on the primary CC or one or more secondary CCs.

In the present example, the UE 315 may receive data from one eNodeB 305-a. However, users on a cell edge may experience high inter-cell interference which may limit the data rates. Multiflow allows UEs to receive data from two eNodeBs 305-a and 305-b and/or other eNodeBs, APs, etc. simultaneously. In some aspects, the two eNodeBs 305-a may be non-collocated and may be configured to support multiple connectivity carrier aggregation. Multiflow works by sending and receiving data from the two eNodeBs 305-a/305-b in two totally separate streams when a UE is in range of two cell towers in two adjacent cells at the same time (see FIG. 5 below). The UE talks to two eNodeB 305-a and/or 305-b simultaneously when the device is on the edge of either eNodeBs' coverage areas. By scheduling two independent data streams to the mobile device from two different eNodeBs at the same time, multiflow can exploit uneven loading in HSPA networks. This may improve the cell edge user experience while increasing network capacity. In one example, throughput data speeds for users at a cell edge may double. In some aspects, multiflow may also refer to the ability of a UE to talk to a WWAN tower (e.g., cellular tower) and a WLAN tower (e.g., AP) simultaneously when the UE is within the reach of both towers. In such cases, the towers may be configured to support carrier aggregation through multiple connections when the towers are not collocated. Multiflow is a feature of LTE/LTE-A that is similar to dual-carrier HSPA, however, there are differences. For example, dual-carrier HSPA may not allow for connectivity to multiple towers to connect simultaneously to a device.

FIG. 4 is a block diagram conceptually illustrating an example of data paths 445 and 450 between a UE 415 and a PDN 440 (e.g., Internet or one or more components to access the Internet) in accordance with an aspect of the present disclosure. The data paths 445, 450 are shown within the context of a wireless communications system 400 for aggregating data from different radio access technologies. The system 200 of FIG. 2 may be an example of portions of the wireless communications system 400. The wireless communications system 400 may include a multi-mode UE 415, an eNodeB 405, a secondary eNodeB 406 that can be coupled to the eNodeB 405 via a backhaul link 438 (e.g., based on a X2 interface), an evolved packet core (EPC) 480, a PDN 440, and a peer entity 455. The UE 415 may include a communicating component 640 for determining processing of antenna selection information for selecting an antenna for communicating with one or more of the multiple cell groups in multiple connectivity, and eNodeB 405 and/or 406 can include a communicating component 1140 for possibly coordinating antenna selection information with other eNodeBs/APs or related cells in one or more cell groups. The multi-mode UE 415 may be configured to support multiple connectivity (e.g., dual connectivity) carrier aggregation. The EPC 480 may include a mobility management entity (MME) 430, a serving gateway (SGW) 432, and a PDN gateway (PGW) 434. A home subscriber system (HSS) 435 may be communicatively coupled with the MME 430. The UE 415 may include an LTE radio 420 and a LTE radio 425. These elements may represent aspects of one or more of their counterparts described above with reference to the previous or subsequent Figures. For example, the UE 415 may be an example of UEs in FIG. 1, FIG. 2, FIG. 3, FIG. 5, FIG. 6, FIG. 11, the eNodeB 405 may be an example of the eNodeBs/base stations/network entities of FIG. 1, FIG. 2, FIG. 3, FIG. 5, FIG. 6, FIG. 11, the eNodeB 406 may be an example of the secondary eNodeB 305-b of FIG. 3. For example, the EPC 480 may be an example of the core network of FIG. 1. The eNodeB 405 and 406 in FIG. 4 may be not be collocated or otherwise may not be in high-speed communication with each other. In addition, in an example, eNodeBs 405 and 406 may communicate with different EPCs 480.

Referring back to FIG. 4, the eNodeB 405 and 406 may be capable of providing the UE 415 with access to the PDN 440 using the aggregation of one or more LTE component carriers (e.g., with one or more eNodeBs). Accordingly, the UE 415 may involve carrier aggregation in dual connectivity, where one connection is to one network entity (eNodeB 405) and the other connection is to a different network entity (eNodeB 406), and each connection may include one or more carriers. It is to be appreciated that UE 415 can communicate with additional eNodeBs 405 and/or 406 via additional communication data paths 445, 450 that traverse the EPC 480 or not to access PDN 440 to provide multiple connectivity with multiple NodeBs and/or APs, carrier aggregation with multiple cells of an eNodeB, etc. Using this access to the PDN 440, the UE 415 may communicate with the peer entity 455. The eNodeBs 405 and/or 406 may provide access to the PDN 440 through the evolved packet core 480 (e.g., through data path 445), and the eNodeB 406 may provide direct access to the PDN 440 (e.g., through data path 450).

The MME 430 may be the control node that processes the signaling between the UE 415 and the EPC 480. Generally, the MME 430 may provide bearer and connection management. The MME 430 may, therefore, be responsible for idle mode UE tracking and paging, bearer activation and deactivation, and SGW selection for the UE 415. The MME 430 may communicate with the eNodeBs 405 and/or 406 over an S1-MME interface. The MME 430 may additionally authenticate the UE 415 and implement Non-Access Stratum (NAS) signaling with the UE 415.

The HSS 435 may, among other functions, store subscriber data, manage roaming restrictions, manage accessible access point names (APNs) for a subscriber, and associate subscribers with MMEs 430. The HSS 435 may communicate with the MME 430 over an S6a interface defined by the Evolved Packet System (EPS) architecture standardized by the 3GPP organization.

All user IP packets transmitted over LTE may be transferred through eNodeB 405 and/or 406 to the SGW 432, which may be connected to the PDN gateway 434 over an S5 signaling interface and the MME 430 over an S11 signaling interface. The SGW 432 may reside in the user plane and act as a mobility anchor for inter-eNodeB handovers and handovers between different access technologies. The PDN gateway 434 may provide UE IP address allocation as well as other functions.

The PDN gateway 434 may provide connectivity to one or more external packet data networks, such as PDN 440, over an SGi signaling interface. The PDN 440 may include the Internet, an Intranet, an IP Multimedia Subsystem (IMS), a Packet-Switched (PS) Streaming Service (PSS), and/or other types of PDNs.

In the present example, user plane data between the UE 415 and the EPC 480 may traverse the same set of one or more EPS bearers, irrespective of whether the traffic flows over data path 445 of the LTE link or data path 450. Signaling or control plane data related to the set of one or more EPS bearers may be transmitted between the LTE radio 420 of the UE 415 and the MME 430 of the EPC 480, by way of the eNodeB 405 and/or 406.

While aspects of FIG. 4 have been described with respect to LTE, similar aspects regarding aggregation and/or multiple connections may also be implemented with respect to UMTS or other similar system or network wireless communications radio technologies.

FIG. 5 is a diagram conceptually illustrating multiple connectivity, in accordance with various aspects of the present disclosure. A wireless communications system 500 may include a master eNodeB 505-a (MeNodeB or MeNB) having a set or group of cells referred to as a master cell group or MCG (or PCG) that may be configured to serve the UE 515. The MCG may include one primary cell (PCell_{MCG}) 510-a and one or more secondary cells 510-b (only one is shown). The wireless communications system 500 may also include a secondary eNodeB 505-b (SeNodeB or SeNB) having a set or group of cells referred to as a secondary cell group or SCG that may be configured to serve the UE 515. The SCG may include one primary cell (PCell_{SCG}) 512-a and one or more secondary cells 512-b (only one is shown). Also shown is a UE 515 that supports carrier aggregation for multiple connectivity (e.g., dual connectivity). The UE 515 may communicate with the MeNodeB 505-a, or a related PCell_{MCG}, via communication link 525-a and with the SeNodeB 505-b. or a related PCell_{SCG}, via communication link 525-b. Moreover, the MeNodeB 505-a and/or SeNodeB 505-b can include a communicating component 1140 for possibly coordinating antenna selection information with other eNodeBs or related cells in one or more cell groups (e.g., the MCG or SCG), and UE 515 may include a communicating component 640 for determining processing of antenna selection information for multiple cell groups in multiple connectivity.

In an example, the UE 515 may aggregate component carriers from the same eNodeB or may aggregate component carriers from collocated or non-collocated eNodeBs. In such an example, the various cells (e.g., different component carriers (CCs)) being used can be easily coordinated because they are either handled by the same eNodeB or by eNodeBs that can communicate control information. When the UE 515, as in the example of FIG. 5, performs carrier aggregation when in communication with two eNodeBs that are non-collocated, then the carrier aggregation operation may be different due to various network conditions. In this case, establishing a primary cell (PCell_{SCG}) in the secondary eNodeB 505-b may allow for appropriate configurations and controls to take place at the UE 515 even though the secondary eNodeB 505-b is non-collocated with the primary eNodeB 505-a.

In the example of FIG. 5, the carrier aggregation may involve certain functionalities by the PCell_{MCG} of the MeNodeB 505-a. For example, the PCell_{MCG} may handle certain functionalities such as physical uplink control channel (PUCCH), contention-based random access control channel (RACH), semi-persistent scheduling, etc. Carrier aggregation with dual or multiple connectivity to non-collocated eNodeBs may include enhancing and/or modifying the manner in which carrier aggregation is otherwise performed. Some of the enhancements and/or modifications may involve having the UE 515 connected to the MeNodeB 505-a and to the SeNodeB 505-b as described above. Other features may include, for example, having a timer adjustment group (TAG) including cells of one of the eNodeBs, having contention-based and contention-free random access (RA) allowed on the SeNodeB 505-b, separate discontinuous reception (DRX) procedures for the MeNodeB 505-a and to the SeNodeB 505-b, having the UE 515 send a buffer status report (BSR) to the eNodeB where the one or more bearers (e.g., eNodeB specific or split bearers) are served, as well as enabling one or more of power headroom report (PHR), power control, semi-persistent scheduling (SPS), and logical channel prioritization in connection with the PCell_{SCG} in the secondary eNodeB 505-b. The enhancements and/or modifications described above, and well as others provided in the disclosure, are intended for purposes of illustration and not of limitation.

For carrier aggregation in dual connectivity, different functionalities may be divided between the MeNodeB 505-a and the SeNodeB 505-b. For example, different functionalities may be statically divided between the MeNodeB 505-a and the SeNodeB 505-b or dynamically divided between the MeNodeB 505-a and the SeNodeB 505-b based on one or more network parameters. In an example, the MeNodeB 505-a may perform upper layer (e.g., above the media access control (MAC) layer) functionality via a PCell_{MCG}, such as but not limited to functionality with respect to initial configuration, security, system information, and/or radio link failure (RLF). As described in the example of FIG. 5, the PCell_{MCG} may be configured as one of the cells of the MeNodeB 505-a that belong to the MCG. The PCell_{MCG} may be configured to provide lower layer functionalities (e.g., MAC/PHY layer) within the MCG.

In an example, the SeNodeB 505-b may provide configuration information of lower layer functionalities (e.g., MAC/PHY layers) for the SCG. The configuration information may be provided by the PCell_{SCG} as one or more radio resource control (RRC) messages, for example. The PCell_{SCG} may be configured to have the lowest cell index (e.g., identifier or ID) among the cells in the SCG. For example, some of the functionalities performed by the SeNodeB 505-b via the PCell_{SCG} may include carrying the PUCCH, configuring the cells in the SCG to follow the DRX configuration of the PCell_{SCG}, configuring resources for contention-based and contention-free random access on the SeNodeB 505-b, carrying downlink (DL) grants having transmit power control (TPC) commands for PUCCH, estimating path loss based on PCell_{SCG} for other cells in the SCG, providing common search space for the SCG, and providing SPS configuration information for the UE 515.

In some aspects, the PCell_{MCG} may be configured to provide upper level functionalities to the UE 515 such as security, connection to a network, initial connection, and/or radio link failure, for example. The PCell_{MCG} may be configured to carry physical uplink control channel (PUCCH) for cells in the MCG, to include the lowest cell index among the MCG, to enable the MCG cells to have the same discontinuous reception (DRX) configuration, to configure random access resources for one or both of contention-based and contention-free random access on the MeNodeB 505-a, to enable downlink grants to convey transmit power control (TPC) commands for PUCCH, to enable path loss estimation for cells in the MCG, to configure common search space for the MeNodeB 505-a, and/or to configure semi-persistent scheduling.

In some aspects, the PCell_{SCG} may be configured to carry PUCCH for cells in the SCG, to include the lowest cell index among the SCG, to enable the SCG cells to have the same DRX configuration, to configure random access resources for one or both of contention-based and contention-free random access on the SeNodeB 505-b, to enable downlink grants to convey TPC commands for PUCCH, to enable path loss estimation for cells in the SCG, to configure common search space for the SeNodeB 505-b, and/or to configure semi-persistent scheduling.

Returning to the example of FIG. 5, the UE 515 may support parallel PUCCH and physical uplink shared channel (PUSCH) configurations for the MeNodeB 505-a and/or the SeNodeB 505-b, though the UE 515 may not be able to provide parallel transmissions for the PUCCH and PUSCH on a given carrier based on a configuration for the carrier, as described further herein. In some cases, the UE 515 may use a configuration (e.g., UE 515 based) that may be applicable to both carrier groups. These PUCCH/PUSCH configurations may be provided through RRC messages, for example.

The UE 515 may also support parallel configuration for simultaneous transmission of acknowledgement (ACK)/negative acknowledgement (NACK) and channel quality indicator (CQI) and for ACK/NACK/sounding reference signal (SRS) for the MeNodeB 505-a and the SeNodeB 505-b. In some cases, the UE 515 may use a configuration (e.g., UE based and/or MCG or SCG based) that may be applicable to both carrier groups. These configurations may be provided through RRC messages, for example.

FIG. 6 is a block diagram 600 conceptually illustrating an example of a UE 615 and components configured in accordance with an aspect of the present disclosure. FIGS. 7, 9, and 10, which are described in conjunction with FIG. 6 herein, illustrate example methods 700, 900, and 1000 in accordance with aspects of the present disclosure. Although the operations described below in FIGS. 7, 9, and 10 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

Referring to FIG. 6, a base station/eNodeB 605-a (MeNodeB with a PCell_{MCG}), an optional base station/eNodeB 605-b (SeNodeB with a PCell_{SCG}), and the UE 615 of diagram 600 may be one of the base stations/eNodeBs (or APs) and UEs as described in various Figures. In an aspect, UE 615 may be configured to perform antenna selection such to select one or more physical or virtual antenna ports that correspond to one or more antennas for communicating with MeNodeB 605-a over communication link 625-a and/or SeNodeB 605-b over communication link 625-b according to aspects described herein. Accordingly, UE 615 may include one or more processors 603 and/or a memory 604 that may be communicatively coupled, e.g., via one or more buses 607, and may operate in conjunction with or otherwise implement a communicating component 640 configured to process antenna selection information received from one or more cells or cell groups to determine which antenna(s) to use in communicating with the one or more cells or cell groups and/or additional cells or cell groups in multiple connectivity. For example, the various operations related to communicating component 640 may be implemented or otherwise executed by one or more processors 603 and, in an aspect, can be executed by a single processor, while in other aspects, different ones of the operations may be executed by a combination of two or more different processors. For example, in an aspect, the one or more processors 603 may include any one or any combination of a modem processor, or a baseband processor, or a digital signal processor, or an application specific integrated circuit (ASIC), or a transmit processor, receive processor, or a transceiver processor associated with transceiver 609. Transceiver 609 may include one or more antennas or related antenna ports, such as ANT1 611, ANT2 613, and/or additional antennas/ports (not shown), which UE 615 can select for communicating with MeNodeB 605-a and/or SeNodeB 605-b. For example, ANT1 611 and/or ANT2 613 may correspond to physical or virtual antenna ports for utilizing one or more antennas of the UE 615 (e.g., antennas 252 in FIG. 2).

Further, for example, the memory 604 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 603. Moreover, memory 604 or computer-readable storage medium may be resident in the one or more processors 603, external to the one or more processors 603, distributed across multiple entities including the one or more processors 603, etc. In addition, transceiver 609 may include one or more RF front end components, such as a transmitter (and/or related processor), a receiver (and/or related processor), etc.

In particular, the one or more processors 603 and/or memory 604 may execute actions or operations defined by communicating component 640 or its subcomponents. For instance, the one or more processors 603 and/or memory 604 may execute actions or operations defined by an information receiving component 650 for receiving antenna selection information from MeNodeB 605-a and/or SeNodeB 605-b for performing antenna selection in the MCG or SCG (e.g., respectively). In an aspect, for example, information receiving component 650 may include hardware (e.g., one or more processor modules of the one or more processors 603) and/or computer-readable code or instructions stored in memory 604 and executable by at least one of the one or more processors 603 to perform the specially configured information receiving operations described herein. Further, for instance, the one or more processors 603 and/or memory 604 may execute actions or operations defined by an antenna selection component 652 for performing antenna selection (e.g., of one or more of ANT1 611, ANT2 613, etc. of transceiver 609) based at least in part on the antenna selection information. In an aspect, for example, antenna selection component 652 may include hardware (e.g., one or more processor modules of the one or more processors 603) and/or computer-readable code or instructions stored in memory 604 and executable by at least one of the one or more processors 603 to perform the specially configured antenna selection operations described herein.

It is to be appreciated that transceiver 609 may be configured to transmit and receive wireless signals through one or more antennas (e.g., ANT1 611, ANT2 613, etc.), an RF front end, one or more transmitters, and one or more receivers. In an aspect, transceiver 609 may be tuned to operate at specified frequencies such that UE 615 can communicate at a certain frequency. In an aspect, the one or more processors 603 may configure transceiver 609 to operate at a specified frequency and power level based on a configuration, a communication protocol, etc. to communicate uplink signals and/or downlink signals, respectively, over related uplink or downlink communication channels.

In an aspect, transceiver 609 can operate in multiple bands (e.g., using a multiband-multimode modem, not shown) such to process digital data sent and received using transceiver 609. In an aspect, transceiver 609 can be multiband and be configured to support multiple frequency bands for a specific communications protocol. In an aspect, transceiver 609 can be configured to support multiple operating networks and communications protocols. Thus, for example, transceiver 609 may enable transmission and/or reception of signals based on a specified modem configuration.

The MeNodeB 605-a, or a PCell_{MCG} related thereto, and the UE 615 may communicate over a first communication link 625-a, which may include one or more carriers (e.g., a plurality of carriers configured in CA). The SeNodeB 605-b, or a PCell_{SCG} related thereto, and the UE 615 may communicate over a second communication link 625-b. UE 615 may be configured to transmit a control channel and/or data channel over one or more carriers with the MeNodeB 605-a and/or SeNodeB 605-b.

For example, UE 615 may include multiple transmit antennas (e.g., one or more antennas 252 as shown in FIG. 2) for communicating (e.g., transmitting uplink communications) with the eNodeB(s) 605-a and/or 605-b. When UE 615 is configured to communicate with eNodeB(s) 605-a and 605-b, the UE may receive antenna selection information from one or more of the eNodeBs 605-a and/or 605-b, and may determine one or more physical or virtual antenna ports (e.g., ANT1 611, ANT2 613, etc. corresponding to the multiple transmit antennas) to select for communicating with eNodeB 605-a and/or 605-b based on the received antenna selection information. In one example, the UE 615 may additionally or alternatively assume that the same transmit antenna port value may be indicated with downlink control information (DCI) (e.g., format 0) in a subframe for the eNodeBs 605-a and/or 605-b. In some instances, eNodeB(s) 605-a and 605-b may not coordinate with each other when communicating DCI to the UE 615 and may cause confusion as to which transmit antenna to use for communicating with eNodeB(s) 605-a and 605-b, respectively.

For example, when UE 615 is configured to use open loop transmit antenna selection (e.g., such that UE 615 may select an uplink transmit antenna port that may be applicable to PUCCH and configurable for PUSCH), the UE 615 may be able to select which uplink transmit antenna port to use to communicate with eNodeB(s) 605-a and 605-b. In the examples described above, however, UE 615 may be configured to use closed loop transmit antenna selection, e.g., such that UE 615 may select an uplink transmit antenna port based at least in part on the most recent DCI received from, and cyclic redundancy check (CRC) masked by, eNodeBs 605-a and 605-b. The antenna selection in this example may be configurable for PUSCH. In one specific example of closed loop transmit antenna selection, UE 615 may be configured to transmit SRS based on switching transmit antenna ports (e.g., alternating between transmitting a first SRS over a first antenna port, and a second SRS over a second antenna port). In any case, it is possible that eNodeB(s) 605-a and 605-b may provide DCI to the UE 615 to configure UE 615 to select the same or different transmit antenna port to communicate with the eNodeB(s) 605-a and 605-b, which may not be supported by UE 615. In addition, when eNodeB(s) 605-a and 605-b are operating asynchronously, it may be difficult for UE 615 to switch between different transmit antennas in closed loop transmit antenna selection when the UE 615 is instructed to communicate using a first transmit antenna during a first time period or interval (e.g., via first antenna selection information from eNodeB 605-a) and to communicate using a second transmit antenna during a second time period or interval (e.g., via second antenna selection information from eNodeB 605-b) when first time period/interval at least partially overlaps with the second time period/interval.

For example, a UE configured with antenna selection for a serving cell may not expect to: be configured with more than one antenna port for an uplink physical channel or signal for a configured serving cell; be configured with trigger type 1 SRS transmission (e.g., aperiodic SRS in LTE) on a configured serving cell; be configured with simultaneous PUCCH and PUSCH transmission; be configured with demodulation reference signal (DM-RS) for PUSCH with orthogonal cover code (OCC) for a configured serving cell; or receive DCI format 0 indicating uplink resource allocation type 1 in LTE for a serving cell. Where the UE is configured with more than one serving cell, the UE may assume the same transmit antenna port value is indicated in each PDCCH/EPDCCH with DCI format 0 in a given subframe in LTE, which may lead to confusion at the serving cells where the serving cells may provide different antenna selection information to the UE. At least some aspects described herein can resolve confusion where serving cells may provide the UE with conflicting antenna selection information.

FIG. 7 illustrates an example method 700 for performing antenna selection in multiple connectivity based on antenna selection information received in one or more cell groups. Method 700 includes, at Block 710, communicating with a first cell group over at least a first carrier. In an aspect, communicating component 640, e.g., in conjunction with one or more processors 603, memory 604, and/or transceiver 609, can communicate with the first cell group over at least the first carrier. For example, the first cell group may include the MCG, and communicating component 640 can communicate with MeNodeB 605-a over communication link 625-a and/or one or more other cells (e.g., SCells) in the MCG, as described. Method 700 also includes, at Block 712, communicating with a second cell group over at least a second carrier. In an aspect, communicating component 640, e.g., in conjunction with one or more processors 603, memory 604, and/or transceiver 609, can also communicate with the second cell group over at least the second carrier. For example, the second cell group may include the SCG, and communicating component 640 can communicate with SeNodeB 605-b over communication link 625-b and/or one or more other cells (e.g., SCells) in the SCG, as described. Thus, communicating component 640 can facilitate multiple connectivity in at least a MCG and SCG in this regard, though it is to be appreciated that communicating component 640 may communicate with additional cell groups as well.

Method 700 also includes, at Block 714, receiving first antenna selection information from the first cell group over at least the first carrier relating to a first interval during which to select a transmit antenna. In an aspect, information receiving component 650, e.g., in conjunction with one or more processors 603, memory 604, and/or transceiver 609, can receive the first antenna selection information from the first cell group (e.g., the MCG) over at least the first carrier (e.g., a carrier in communication link 625-a) relating to the first interval during which to select the transmit antenna (e.g., a physical or virtual antenna port configured at the UE 615). For example, the antenna selection information can relate to information the communicating component 640 can utilize in determining to switch an antenna (or related antenna port) for transmitting communications to the MeNodeB 605-a over communication link 625-a. For example, the antenna selection information can relate to a time interval for which to switch the antenna, an antenna port to which to switch during the time interval, etc. In a specific example, the antenna selection information may include a DCI format 0 message, and antenna selection component 652 can determine to switch the transmit antenna to a different antenna (e.g. from ANT1 611 to ANT2 613, or otherwise from one physical or virtual antenna port to a different physical or virtual antenna port) at a subframe related to receiving the DCI format 0 message (e.g., a subframe specified in the message or otherwise occurring a configured number of subframes following receipt of the DCI format 0 message).

In multiple connectivity, the UE 615 can communicate with multiple PCells, and thus method 700 may additionally include, at Block 716, receiving second antenna selection information from the second cell group over at least the second carrier relating to a second interval during which to select a transmit antenna. In an aspect, information receiving component 650, e.g., in conjunction with one or more processors 603, memory 604, and/or transceiver 609, can also receive the second antenna selection information from the second cell group (e.g., the SCG) over at least the second carrier (e.g., a carrier in communication link 625-b) relating to the second interval during which to select the transmit antenna. As described, in an example, the first and second intervals may be the same interval (e.g., where the cell groups are synchronized in time) and/or overlapping intervals (e.g., where the cell groups are not synchronized in time). Thus, where the UE 615 cannot support separate and/or contemporaneous antenna selection for both cell groups, undesirable or unexpected switching of the transmit antenna may occur for at least one of the cell groups.

Accordingly, method 700 includes, at Block 718, determining whether to perform antenna selection based at least in part on the first antenna selection information and/or the second antenna selection information. In an aspect, antenna selection component 652, e.g., in conjunction with one or more processors 603, memory 604, and/or transceiver 609, can determine whether to perform antenna selection based at least in part on the first antenna selection information and/or the second antenna selection information. Where the UE 615 is capable of supporting separate and/or contemporaneous antenna selection for multiple cell groups and/or related component carriers (CC), this can optionally include, at Block 720, indicating to one or more of the first or second cell groups an ability to separately and/or contemporaneously perform antenna selection with the first cell group and the second cell group (and/or an ability to separately and/or contemporaneously perform antenna selection with the first and/or second cell group over multiple CCs). In an aspect, antenna selection component 652, e.g., in conjunction with one or more processors 603, memory 604, and/or transceiver 609, can indicate to one or more of the first or second cell groups (e.g., the MCG or SCG, which may include indicating to the MeNodeB 605-a, SeNodeB 605-b, and/or other eNodeBs in the cell groups) the ability of the UE 615 to separately and/or contemporaneously perform antenna selection with the first cell group and the second cell group and/or over the related CCs based on multiple antenna port configurations (e.g., as part of a capability indicator communicated to the eNodeBs). In this case, antenna selection component 652 can perform a first antenna selection based on the first antenna selection information for the first cell group and a second antenna selection based on the second antenna selection information for the second cell group, and may do so separately and/or contemporaneously (e.g., or at least in the same or overlapping first and second time intervals). In another example, antenna selection component 652 can perform a first antenna selection based on the first antenna selection information for one CC with the first cell group and/or second cell group and perform a second antenna selection based on the second antenna selection information for another CC with the first cell group and/or the second cell group, and may do so separately and/or contemporaneously (e.g., or at least in the same or overlapping first and second time intervals).

In addition, for example, where the UE 615 supports separately and/or contemporaneously performing antenna selection for the multiple cell groups or related carriers, antenna selection component 652 may select, and/or communicating component 640 may transmit uplink signals using, the same or different antenna port for the first cell group and the second cell group (and/or for different CCs over the first and/or second cell groups). In either case, the first cell group and second cell group can cause the UE 615 to perform antenna selection for the related cell group regardless of whether the antenna selections occur in the same or overlapping time intervals.

In an example, determining whether to perform antenna selection based on the first or second antenna selection information at Block 718 (e.g., where separately and/or contemporaneously performing antenna selection for multiple cell groups is not supported) may optionally include, at Block 722, determining whether the first cell group or the second cell group has a higher priority for antenna selection. In an aspect, antenna selection component 652, e.g., in conjunction with one or more processors 603, memory 604, and/or transceiver 609, may determine whether the first cell group or the second cell group has a higher priority for antenna selection. For example, antenna selection component 652 may determine that the first cell group (e.g., MCG) has higher priority than the second cell group (e.g., SCG), and may accordingly determine to perform antenna selection based on the antenna selection information (e.g., DCI format 0) from the MCG while ignoring antenna selection information (e.g., DCI format 0) from the SCG (and/or additional cell groups). This may also include antenna selection component 652 receiving, in configuration information (e.g., configuration information stored within the UE 615, configuration information received in an RRC configuration from the network, etc.), an indication to prioritize antenna selection information from the MCG (or certain cell groups) over other cell groups.

Additionally, for example, the antenna selection component 652 may determine whether to perform antenna selection based on the first antenna selection information or the second antenna selection information based on a determination that the first and second antenna selection information relate to the same or overlapping time intervals. In addition, in an example, the antenna selection component 652 may determine whether to perform antenna selection based on information from one of the cell groups regardless of whether conflicting information is received for the same or overlapping time intervals. In this regard, for example, antenna selection component 652 may perform antenna selection based on the latest received antenna selection information (e.g., DCI format 0) received across the first and second (or additional) cell groups. Accordingly, antenna selection component 652 may determine whether to perform antenna selection based on information from the first or second cell group where conflicting information is received for the same or overlapping interval (e.g., the first and second antenna selection information indicating different antenna ports), as described. Thus, in this example, as described, antenna selection component 652 may then determine whether to give the first or second cell group a higher priority for considering the related antenna selection information (e.g., based on a defined or received configuration, etc.).

Moreover, in an example, method 700 may optionally include, at Block 724, indicating whether antenna selection is performed based on the first antenna selection information or the second antenna selection information. In an aspect, antenna selection component 652, e.g., in conjunction with one or more processors 603, memory 604, and/or transceiver 609, can indicate whether antenna selection is performed based on the first antenna selection information or the second antenna selection information (e.g., where the UE 615 may not support separately or contemporaneously performing antenna selection for multiple cell groups). Thus, for example, antenna selection component 652 may determine whether to utilize the first or second antenna selection information in performing antenna selection, and may indicate whether it utilizes the first or second antenna selection information to one or more of the cell groups (e.g., MeNodeB 605-a, SeNodeB 605-b, and/or one or more other eNodeBs in the MCG and/or SCG). Thus, for example, the first and/or second cell group may determine whether the UE 615 performs antenna selection for the respective cell group based at least in part on the indication from the UE 615 in determining which antenna over which to expect transmissions from the UE 615.

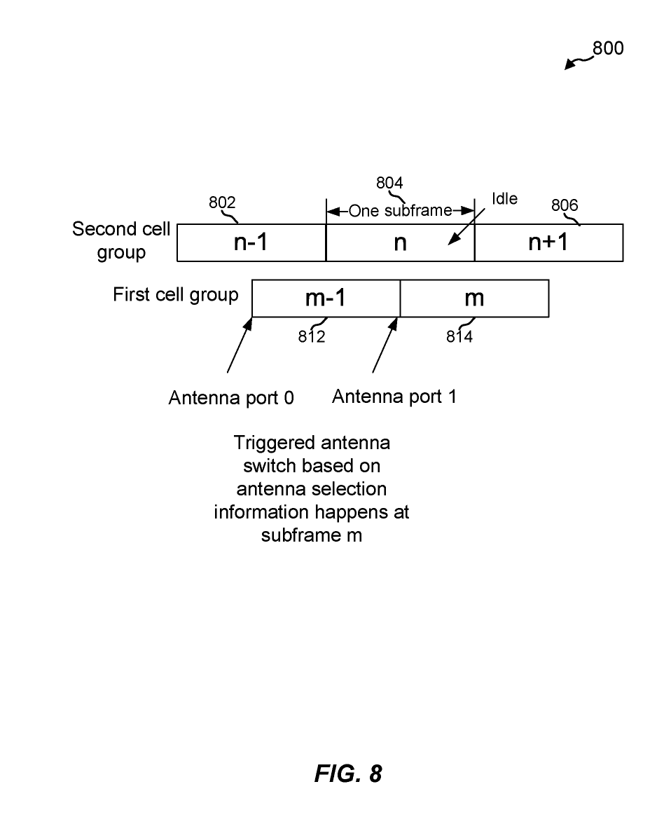

Method 700 can optionally include, at Block 726, providing an idle period for transmitting to the second cell group over at least the second carrier in the second interval based at least in part on determining that the second interval overlaps the first interval. In an aspect, communicating component 640, e.g., in conjunction with one or more processors 603, memory 604, and/or transceiver 609, can provide the idle period for transmitting to the second cell group (e.g., the SCG) over at least the second carrier (e.g., a carrier in communication link 625-b) in the second interval based at least in part on determining that the second interval overlaps the first interval. An example is depicted in FIG. 8, which illustrates example asynchronous timelines 800 of subframes for multiple cell groups. For example, a timeline for the second cell group can include subframes 802, 804, 806 which are offset in time from a timeline for the first cell group including subframes 812, 814. In this example, antenna selection information can be received from the first cell group for subframe 814, which overlaps subframes 804 and 806 for the second cell group. Accordingly, communicating component 640 may provide an idle period for the second cell group at least in subframe 804 to avoid transmitting communications to the second cell group using the newly selected antenna.

For example, where information receiving component 650 receives the first antenna selection information indicating an antenna selection in an upcoming time interval (e.g., at least 4 ms or 4 subframes in LTE), antenna selection component 652 can determine to perform antenna selection based on the first antenna selection information in the first time interval, and communicating component 640 can refrain from transmitting uplink communications to the second cell group in the first time interval. In one example, antenna selection component 652 can also determine that conflicting antenna selection information is received from the second cell group for the same or overlapping interval, and communicating component 640 can provide the idle period such to refrain from transmitting to the second cell group in the first time interval based further at least in part on determining the conflicting antenna selection information.

In one example where the UE does not provide the idle period, however, the antenna selection component 652 may perform antenna selection as instructed in the first and/or second antenna selection information, and the MeNodeB 605-a and/or SeNodeB 605-b may expect that uplink transmissions in the related cell groups (e.g., MCG and/or SCG) may have data/control symbols using a first antenna (or related port) while DM-RS symbols may use a second antenna (or related port) based on switching for one cell group as in the related antenna selection information.

Method 700 can optionally include, at Block 728, selecting, and/or transmitting communications over, one or more antennas based on the first antenna selection information and/or the second antenna selection information. In an aspect, communicating component 640, e.g., in conjunction with one or more processors 603, memory 604, transceiver 609, and/or antenna selection component 652, can select, and/or transmit communications over, one or more antennas (e.g., ANT1 611, ANT2 613, etc.) based on the first antenna selection information and/or the second antenna selection information. For example, where antenna selection component 652 determines to perform antenna selection (e.g., as described with respect to Block 718 and/or optional Blocks 720, 722, 724 above), communicating component 640 can transmit communications to the MeNodeB 605-a and/or SeNodeB 605-b over the selected antenna(s).

Moreover, in an example where the UE 615 does not support separately and/or contemporaneously performing antenna selection for multiple cell groups, antenna selection component 652 may indicate to the MeNodeB 605-a, SeNodeB 605-b, and/or one or more other cells or related eNodeBs in the first and/or second cell group that closed loop antenna switching is disabled for the UE 615.

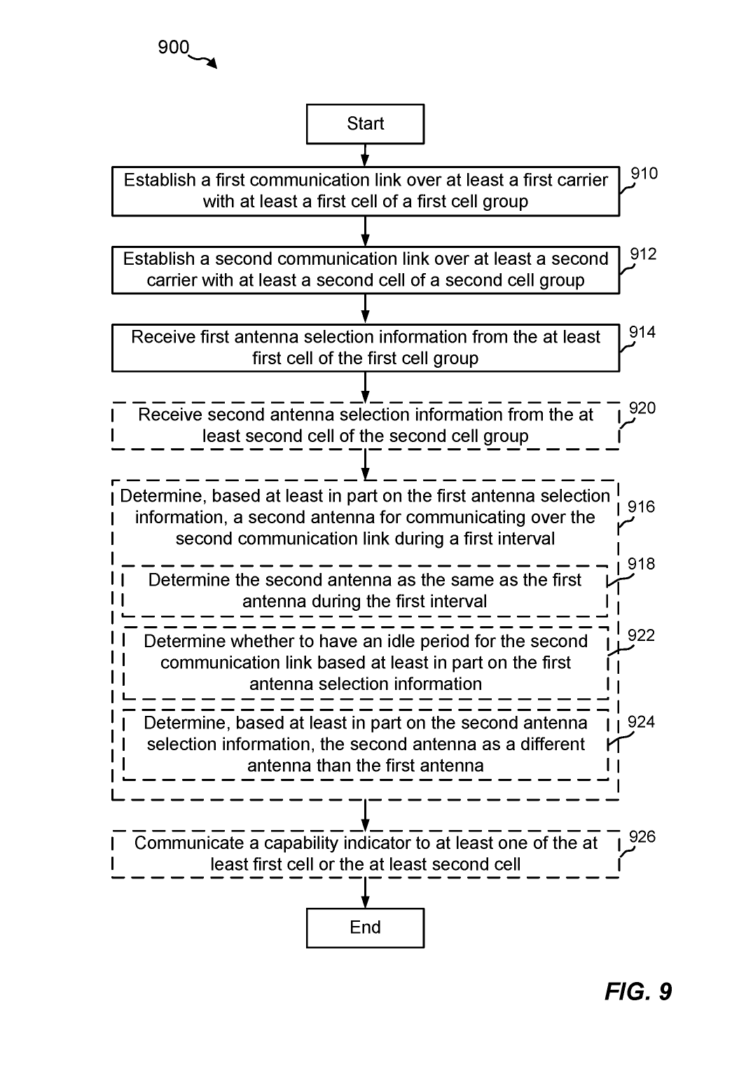

FIG. 9 illustrates another example method 900 for performing antenna selection in multiple connectivity based on antenna selection information received in one or more cell groups. Method 900 includes, at Block 910, establishing a first communication link over at least a first carrier with at least a first cell of a first cell group. In an aspect, communicating component 640, e.g., in conjunction with one or more processors 603, memory 604, and/or transceiver 609, can establish the first communication link over at least the first carrier with at least the first cell of the first cell group. For example, communicating component 640 may perform an access procedure (e.g., over a random access channel) to establish the first communication link with the first cell. In any case, the first cell, which may be provided by MeNodeB 605-a may allow UE 615 to establish the first communication link 625-a. In one example, MeNodeB 605-a may add one or more cells to the cell group (e.g., MCG) for UE 615 to provide the cell group in multiple connectivity, as described herein.

Method 900 also includes, at Block 912, establishing a second communication link over at least a second carrier with at least a second cell of a second cell group. In an aspect, communicating component 640, e.g., in conjunction with one or more processors 603, memory 604, and/or transceiver 609, can establish the second communication link over at least the second carrier with at least the second cell of the second cell group. For example, communicating component 640 may perform an access procedure (e.g., over a random access channel) to establish the second communication link with the second cell. In another example, MeNodeB 605-a may configure the UE 615 with one or more parameters for establishing the second communication link to the second cell (e.g., a cell provided by SeNodeB 605-b and/or other cells). In any case, the second cell, which may be provided by SeNodeB 605-b may allow UE 615 to establish the second communication link 625-b. In one example, MeNodeB 605-a and/or SeNodeB 605-b may add one or more cells to the cell group (e.g., SCG) for UE 615 to provide the cell group in multiple connectivity, as described herein.

Method 900 also includes, at Block 914, receiving first antenna selection information from the at least first cell of the first cell group. In an aspect, information receiving component 650, e.g., in conjunction with one or more processors 603, memory 604, and/or transceiver 609, can receive the first antenna selection information from the at least first cell of the first cell group. The first antenna selection information may relate to a first interval during which the UE 615 is to select a first antenna or related physical or virtual antenna port(s). For example, MeNodeB 605-a, or another eNodeB providing a cell in the MCG, can generate first antenna selection information for causing the UE 615 to configure one or more antennas for communicating with the MeNodeB 605-a or related cell group in uplink communications. As described, in one example, the MeNodeB 605-a and SeNodeB 605-b may be synchronized, and the first antenna selection information may correspond to antenna selection for communicating with both the MeNodeB 605-a and SeNodeB 605-b in the first interval (e.g., in a given subframe, collection of subframes, radio frame, etc.).

Method 900 also optionally includes, at Block 916, determining, based at least in part on the first antenna selection information, a second antenna for communicating over the second communication link during a first interval. In an aspect, antenna selection component 652, e.g., in conjunction with one or more processors 603, memory 604, and/or transceiver 609, can determine, based at least in part on the first antenna selection information, the second antenna (e.g., ANT1 611, ANT2 613, etc.) for communicating over the second communication link during the first interval. In one example, where the MeNodeB 605-a and SeNodeB 605-b are synchronized, for example, determining the second antenna at Block 916 may optionally include, at Block 918, determining the second antenna as the same as the first antenna during the first interval. In an aspect, antenna selection component 652, e.g., in conjunction with one or more processors 603, memory 604, and/or transceiver 609, can determine the second antenna (e.g., ANT1 611, ANT2 613, etc.) as the same as the first antenna during the first interval (e.g., based on the first antenna selection information). In one example, as described, further herein, the MeNodeB 605-a and SeNodeB 605-b may coordinate antenna selection information for the UE 615 (e.g., MeNodeB 605-a can notify SeNodeB 605-b of sending antenna selection information to the UE 615 and/or vice versa to allow the eNodeBs 605-a, 605-b to communicate with the UE 615 based on the antenna selection information).

In another example, method 900 may optionally include, at Block 920, receiving second antenna selection information from the at least second cell of the second cell group. In an aspect, information receiving component 650, e.g., in conjunction with one or more processors 603, memory 604, and/or transceiver 609, may receive second antenna selection information from the at least second cell of the second cell group as well. As described, in one example, the first cell (e.g., MeNodeB 605-a) and the second cell (SeNodeB 605-b) or related cell groups may not be synchronized and/or may not communicate to ensure conflicting antenna selection information is not provided to the UE 615. Thus, the UE 615 can determine whether and/or how to use the first antenna selection information and/or the second antenna selection information in selecting one or more antennas for communicating with the first cell or cell group (e.g., MeNodeB 605-a or related MCG) and/or the second cell or cell group (e.g., SeNodeB 605-b or related SCG).

In one example, antenna selection component 652 may determine to use antenna selection information for one cell or cell group (e.g., and/or to prioritize antenna selection information from one cell or cell group over another cell or cell group). As described, determining the second antenna for communicating over the second communication link during the first interval at Block 916 may optionally include, at Block 918, determining the second antenna as the same as the first antenna during the first interval. Thus, for example, antenna selection component 652 can determine the second antenna as the same as the first antenna during the first interval. In one example, MeNodeB 605-a or other network components (e.g., via an RRC configuration) may configure UE 615 to prefer or prioritize antenna selection information from MeNodeB 605-a over that from SeNodeB 605-b or to otherwise only use antenna selection information from MeNodeB 605-a. In another example, antenna selection component 652 can determine the second antenna based on a configured priority, which may include a priority indicating to prefer antenna selection information from an MeNodeB over an SeNodeB. In either case, in this example, antenna selection component 652 can utilize the first antenna selection information received from the first cell or cell group for performing antenna selection for communicating with both the MeNodeB 605-a, or related MCG, and SeNodeB 605-b, or related SCG (e.g., regardless of other antenna selection information received from other cells, such as the second antenna selection information received from the at least second cell).

In addition, for example, the MeNodeB 605-a and SeNodeB 605-b may be asynchronous, as described, and thus antenna selection information for one of the eNodeBs for switching the antenna (or related port) may be received while communicating with another eNodeB (e.g., during an uplink transmission by the UE 615 in an overlapping time interval). This may result in the UE 615 transmitting uplink control/data to an eNodeB using one antenna while transmitting DM-RS in the same subframe using a different antenna, which may lead to undesirable demodulation results at the eNodeB. In this example, determining the second antenna at Block 916 may optionally include, at Block 922, determining whether to have an idle period for the second communication link based at least in part on the first antenna selection information. In an aspect, communicating component 640, e.g., in conjunction with one or more processors 603, memory 604, and/or transceiver 609, may determine whether to have an idle period for the second communication link 625-b (e.g., where determining the second antenna may include determining to use no antenna, dropping a scheduled transmission, etc.) based at least in part on the first antenna selection information. For example, since there may be at least 4 ms before receiving a DCI format 0 from MeNodeB 605-a and the corresponding UL transmission (e.g., in LTE), for antenna switch due in a subframe m, based on the first antenna selection information, the corresponding DCI format 0 is at subframe m−4 or earlier, such that communicating component 640 can determine that subframe n, which overlaps subframe m for communicating with SeNodeB 605-b, can be idle based on determining that there is antenna switch in the MCG based on the first antenna selection information. In another example, communicating component 640 can determine the idle period based at least in part on determining the antenna switch initiated in the MCG (e.g., by MeNodeB 605-a) may cause different antennas (or related ports) for the data/control symbols and the DM-RS symbols of an uplink transmission in subframe n in the SCG (e.g., to SeNodeB 605-b). An example is shown and described above in FIG. 8.

In another example, determining the second antenna at Block 916 may optionally include, at Block 924, determining, based at least in part on the second antenna selection information, the second antenna as a different antenna than the first antenna. In an aspect, antenna selection component 652, e.g., in conjunction with one or more processors 603, memory 604, and/or transceiver 609, may determine, based at least in part on the second antenna selection information, the second antenna as a different antenna (e.g., ANT1 611, ANT2 613, etc.) than the first antenna (e.g., for communicating over the second communication link 625-b). Thus, in one example, antenna selection component 652 can proceed with the antenna switching based on the first antenna selection information, and communicating component 640 can transmit control/data to SeNodeB 605-b using a first antenna and DM-RS using a second antenna in the first interval (or at least a portion thereof where the cell groups are asynchronous) based on the antenna selection information. Moreover, in an example, UE 615 may support communicating over multiple carriers using different antennas (e.g., different antenna port configurations), and antenna selection component 652 may accordingly determine the one or more antennas for communicating over the first communication link 625-a based on the first antenna selection information and the one or more different antennas for communicating over the second communication link 625-b based on the second antenna selection information.

Method 900 may also optionally include, at Block 926, communicating a capability indicator to at least one of the at least first cell or the at least second cell. In an aspect, antenna selection component 652, e.g., in conjunction with one or more processors 603, memory 604, and/or transceiver 609, may communicate the capability indicator to at least one of the at least first cell (e.g., MeNodeB 605-a) or the at least second cell (e.g., SeNodeB 605-b). For example, the capability indicator may indicate a capability of the UE 615 to communicate with multiple cells using multiple antennas and/or related antenna port configurations. In an example, determining the second antenna at Block 916 may be further based on the capability indicator (e.g., determine the second antenna based on second antenna selection information received at Block 920 or not). Moreover, as described in further detail below, MeNodeB 605-a and/or SeNodeB 605-b may use the capability indicator in determining whether to send antenna selection information to UE 615, whether to coordinate antenna selection information, whether to configure a priority for determine which antenna selection information for the UE 615 to process, etc. In one example, the capability indicator indicates support of the UE 615 for communicating with multiple cells using multiple antenna port configurations. In another example, the capability indicator may indicate no support of communicating with multiple cells using multiple antenna port configurations. In this example, communicating component 640 may disable closed loop antenna selection for one or more antennas and/or related antenna ports of UE 615. Disabling closed loop antenna selection may include enabling open loop antenna selection for one or more antennas, disabling all switching or selection over one or more antennas, etc. for a given cell group and/or all cells or cell groups.

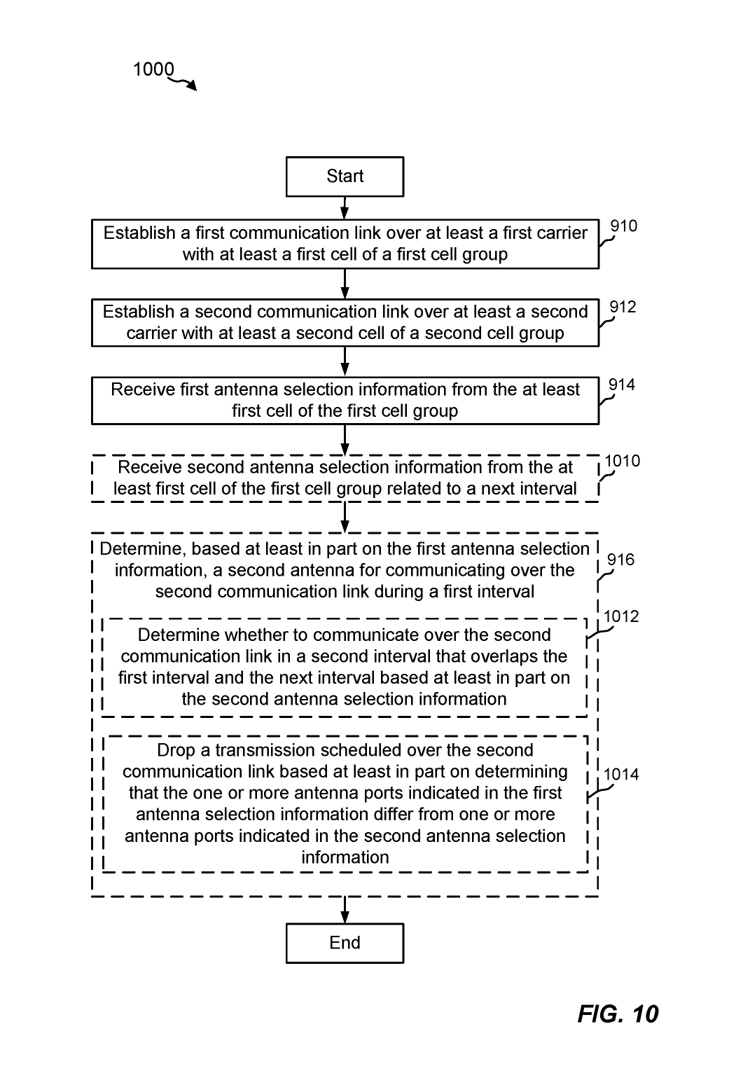

FIG. 10 illustrates another example method 1000 for performing antenna selection in multiple connectivity based on antenna selection information received in one or more cell groups. Method 1000 includes, at Block 910, establishing a first communication link over at least a first carrier with at least a first cell of a first cell group, as described above in method 900. In an aspect, communicating component 640, e.g., in conjunction with one or more processors 603, memory 604, and/or transceiver 609, can establish the first communication link over at least the first carrier with at least the first cell of the first cell group. For example, communicating component 640 may perform an access procedure (e.g., over a random access channel) to establish the first communication link with the first cell. In any case, the first cell, which may be provided by MeNodeB 605-a may allow UE 615 to establish the first communication link 625-a. In one example, MeNodeB 605-a may add one or more cells to the cell group (e.g., MCG) for UE 615 to provide the cell group in multiple connectivity, as described herein.

Method 1000 also includes, at Block 912, establishing a second communication link over at least a second carrier with at least a second cell of a second cell group, as described above in method 900. In an aspect, communicating component 640, e.g., in conjunction with one or more processors 603, memory 604, and/or transceiver 609, can establish the second communication link over at least the second carrier with at least the second cell of the second cell group. For example, communicating component 640 may perform an access procedure (e.g., over a random access channel) to establish the second communication link with the second cell. In another example, MeNodeB 605-a may configure the UE 615 with one or more parameters for establishing the second communication link to the second cell (e.g., a cell provided by SeNodeB 605-b and/or other cells). In any case, the second cell, which may be provided by SeNodeB 605-b may allow UE 615 to establish the second communication link 625-b. In one example, MeNodeB 605-a and/or SeNodeB 605-b may add one or more cells to the cell group (e.g., SCG) for UE 615 to provide the cell group in multiple connectivity, as described herein.

Method 1000 also includes, at Block 914, receiving first antenna selection information from the at least first cell of the first cell group, as described above in method 900. In an aspect, information receiving component 650, e.g., in conjunction with one or more processors 603, memory 604, and/or transceiver 609, can receive the first antenna selection information from the at least first cell of the first cell group. The first antenna selection information may relate to a first interval during which the UE 615 is to select a first antenna or related physical or virtual antenna port(s). For example, MeNodeB 605-a, or another eNodeB providing a cell in the MCG, can generate first antenna selection information for causing the UE 615 to configure one or more antennas for communicating with the MeNodeB 605-a or related cell group in uplink communications. As described, in one example, the MeNodeB 605-a and SeNodeB 605-b may be synchronized, and the first antenna selection information may correspond to antenna selection for communicating with both the MeNodeB 605-a and SeNodeB 605-b in the first interval (e.g., in a given subframe, collection of subframes, radio frame, etc.).

Method 1000 also optionally includes, at Block 916, determining, based at least in part on the first antenna selection information, a second antenna for communicating over the second communication link during a first interval, as described above in method 900 and additionally with respect to the additional optional Blocks explained below. In an aspect, antenna selection component 652, e.g., in conjunction with one or more processors 603, memory 604, and/or transceiver 609, can determine, based at least in part on the first antenna selection information, the second antenna (e.g., ANT1 611, ANT2 613, etc.) for communicating over the second communication link during the first interval. In one example, where the MeNodeB 605-a and SeNodeB 605-b are synchronized, for example, determining the second antenna at Block 916 may optionally include, at Block 918, determining the second antenna as the same as the first antenna during the first interval. In an aspect, antenna selection component 652, e.g., in conjunction with one or more processors 603, memory 604, and/or transceiver 609, can determine the second antenna (e.g., ANT1 611, ANT2 613, etc.) as the same as the first antenna during the first interval (e.g., based on the first antenna selection information).

In an example, method 1000 may optionally include, at Block 1010, receiving second antenna selection information from the at least first cell of the first cell group related to a next interval. In an aspect, information receiving component 650, e.g., in conjunction with one or more processors 603, memory 604, and/or transceiver 609, may receive second antenna selection information from the at least first cell of the first cell group related to a next interval (e.g., a subsequent interval from the first interval). For example, the second antenna selection information may correspond to switching antennas (and/or related ports) in communicating with the first cell group in the next interval. For example, referring to FIG. 8, information receiving component 650 may receive first antenna selection information to select antenna port 0 for a first time interval (subframe 812) and receive second antenna selection information to select antenna port 1 for a next time interval (subframe 814). It is to be appreciated that the next time interval may or may not be the next adjacent time interval, but may include a number of time intervals after the first interval.

In this example, determining the second antenna at Block 916 may also optionally include, at Block 1012, determining whether to communicate over the second communication link in a second interval that overlaps the first interval and the next interval based at least in part on the second antenna selection information. In an aspect, antenna selection component 652 and/or communicating component 640, e.g., in conjunction with one or more processors 603, memory 604, and/or transceiver 609, may determine whether to communicate over the second communication link in a second interval that overlaps the first interval and the next interval based at least in part on the second antenna selection information. For example, antenna selection component 652 may determine whether to select an antenna, and/or communicating component 640 may determine whether to have an idle period in the second interval, as described above, and as shown in FIG. 8 with respect to subframe 804 (e.g., the second time interval) that overlaps subframes 812, 814. Thus, for example, based on the antenna switching identified from the first and second antenna selection information (e.g., and/or based additionally on antenna selection information related to the second cell), antenna selection component 652 may determine whether to select an antenna, and/or communicating component 640 may determine whether to have an idle period to avoid transmitting over the switched antenna when the second cell group may not be expecting communications from the switched antenna (and/or related antenna port).

In another example, determining the second antenna at Block 916 may also optionally include, at Block 1012, dropping a transmission scheduled over the second communication link based at least in part on determining that one or more antenna ports indicated in the first antenna selection information differ from one or more antenna ports indicated in the second antenna selection information. In an aspect, communicating component 640, e.g., in conjunction with one or more processors 603, memory 604, and/or transceiver 609, may drop the transmission scheduled over the second communication link 625-b based at least in part on determining that the one or more antenna ports indicated in the first antenna selection information differ from one or more antenna ports indicated in the second antenna selection information. Thus, for example, where the antenna selection information indicates to switch antennas for the first cell group (e.g., as for subframes 812, 814 in FIG. 8), communicating component 640 may drop a transmission scheduled for the second cell group at least in an overlapping interval (e.g., subframe 804 in FIG. 8) to prevent receiving communications from the switched antenna by the second cell group, where the communications via the switched antenna may cause undesired results, as described above. Moreover, in an example, where the UE 615 is not configured to utilize different antenna port configurations for communicating with multiple cells and receives the antenna selection information indicating an antenna switch, UE 615 can drop the transmissions for one cell in performing antenna switching based on antenna selection information for another cell.

FIG. 11 is a block diagram 1100 conceptually illustrating an example of a network entity 1105 and components configured in accordance with various aspects of the present disclosure. FIGS. 12 and 13, which are described in conjunction with FIG. 11 herein, illustrates example methods 1200, 1300 in accordance with aspects of the present disclosure. Although the operations described below in FIGS. 12 and 13 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

Referring to FIG. 11, diagram 1100 includes a network entity 1105-a and network entity 1105-b, which can include one or more previously described base stations/eNodeBs (e.g., MeNodeB 605-a with a PCell_{MCG}, SeNodeB with a PCell_{SCG}, related cells, etc.), or other network entities, along with a UE 1115, which can include one or more previously described UEs (e.g., UE 615).

In an aspect, network entity 1105-a may include one or more processors 1103 and/or a memory 1104 that may be communicatively coupled, e.g., via one or more buses 1107, and may operate in conjunction with or otherwise implement a communicating component 1140 configured to coordinate antenna selection information for providing the UE 115 to prevent the UE 115 receiving conflicting information. For example, the various functions related to communicating component 1140 may be implemented or otherwise executed by one or more processors 1103 and, in an aspect, can be executed by a single processor, while in other aspects, different ones of the functions may be executed by a combination of two or more different processors, as described above. It is to be appreciated, in one example, that the one or more processors 1103 and/or memory 1104 may be configured as described in examples above with respect to the one or more processors 603 and/or memory 604 of UE 615.

In an example, the one or more processors 603 and/or memory 604 may execute actions or operations defined by communicating component 1140 or its subcomponents. For instance, the one or more processors 1103 and/or memory 1104 may execute actions or operations defined by an information generating component 1150 for generating antenna selection information for a UE to perform antenna selection. In an aspect, for example, information generating component 1150 may include hardware (e.g., one or more processor modules of the one or more processors 1103) and/or computer-readable code or instructions stored in memory 1104 and executable by at least one of the one or more processors 1103 to perform the specially configured information generating operations described herein. Further, for instance, the one or more processors 1103 and/or memory 1104 may execute actions or operations defined by an information communicating component 1152 for communicating the antenna selection information to the UE and/or a portion of antenna selection information to one or more network entities. In an aspect, for example, information communicating component 1152 may include hardware (e.g., one or more processor modules of the one or more processors 1103) and/or computer-readable code or instructions stored in memory 1104 and executable by at least one of the one or more processors 1103 to perform the specially configured information communicating operations described herein.

It is to be appreciated that transceiver 1109 may be configured to transmit and receive wireless signals through an RF front end, one or more transmitters, one or more receivers, respective antennas, etc. In an aspect, transceiver 1109 may be tuned to operate at specified frequencies such that network entity 1105-a can communicate at a certain frequency. In an aspect, the one or more processors 1103 may configure transceiver 1109 to operate at a specified frequency and power level based on a configuration, a communication protocol, etc. to communicate uplink signals and/or downlink signals, respectively, over related uplink or downlink communication channels.

In an aspect, transceiver 1109 can operate in multiple bands (e.g., using a multiband-multimode modem, not shown) such to process digital data sent and received using transceiver 1109. In an aspect, transceiver 1109 can be multiband and be configured to support multiple frequency bands for a specific communications protocol. In an aspect, transceiver 1109 can be configured to support multiple operating networks and communications protocols. Thus, for example, transceiver 1109 may enable transmission and/or reception of signals based on a specified modem configuration.

The network entity 1105-a and the UE 1115 may communicate over first communication link 1125-a, and the network entity 1105-b and UE 1115 may communicate over second communication link 1125-b. Furthermore, network entities 1105-a and 1105-b may communicate over a backhaul link 1134.

FIG. 12 illustrates an example method 1200 for coordinating antenna selection information for a UE among a plurality of network entities, in accordance with various aspects of the present disclosure. Method 1200 includes, at Block 1210, communicating with a UE in a first cell group. In an aspect, communicating component 1140, e.g., in conjunction with processor(s) 1103, memory 1104, and/or transceiver 1109, can communicate with the UE 1115 in the first cell group (e.g., an MCG or SCG). For example, communicating component 1140 can communicate with the UE 1115 over at least a first carrier of communication link 1125-a. Moreover, network entity 1105-a may configure the UE 1115 to communicate with additional cells in the cell group, additional cells in other cell groups (e.g., network entity 1105-b), etc., in multiple connectivity.

Method 1200 may include, at Block 1212, transmitting first antenna selection information to the UE for the first cell group. In an aspect, information generating component 1150, e.g., in conjunction with processor(s) 1103, memory 1104, and/or transceiver 1109, can generate the first antenna selection information, and communicating component 1140 can transmit the first antenna selection information to the UE 1115 for the first cell group (e.g., the MCG or SCG that includes network entity 1105-a). As described, the first antenna selection information can include information related to switching antennas (e.g., a physical or virtual antenna port) at the UE 1115 in transmitting subsequent uplink communications to the network entity 1105-a and/or other cells in the cell group (e.g., at a time interval). For instance, the antenna selection information may include a DCI format 0 message, as described. It is possible, where the UE 1115 is configured for multiple connectivity, that antenna selection information generated and transmitted by communicating component 1140 may conflict with antenna selection information received from other configured cell groups (e.g., a separate cell group to which network entity 1105-b belongs).

Thus, in one example, method 1200 further includes, at Block 1214, transmitting at least a portion of the first antenna selection information to one or more cells in a second cell group over a backhaul connection. In an aspect, information communicating component 1152, e.g., in conjunction with processor(s) 1103, memory 1104, and/or transceiver 1109, can transmit at least the portion of the first antenna selection information to the one or more cells in the second cell group (e.g., network entity 1105-b) over the backhaul link 1134. The portion of the antenna selection information can include an indication of an action or configured modification period (e.g., a time interval) during which the antenna selection information was sent to the UE 1115 or for each possible antenna selection change in the first cell group, a specific indication of a system time at or during which the UE 1115 is to switch antennas, an antenna (e.g., physical or virtual antenna port) to which the UE 1115 is to switch, etc. as indicated to the UE 1115 in the first antenna selection information. In this regard, network entity 1105-b can receive the portion of the antenna selection information and can accordingly determine the antenna switch, refrain from scheduling uplink transmissions for the UE 1115 in a same or overlapping time interval, etc., as described herein. In another example, the network entity 1105-a and network entity 1105-b may communicate/negotiate a transmit antenna selection interval (e.g., action time or switching period) for each of the network entities 1105-a and 1105-b. For example, the network entity 1105-a (e.g., a MeNB) may communicate to the network entity 1105-b (e.g., a SeNB) based on an antenna selection interval and an antenna (or related antenna port) that may be switched to during the antenna selection interval (e.g., subframe 814 in FIG. 8).

Thus, method 1200 may also include, at Block 1216, receiving an indication of second antenna selection information communicated to the UE in a second cell group. For example, communicating component 1140, e.g., in conjunction with processor(s) 1103, memory 1104, and/or transceiver 1109, can receive the indication of the second antenna selection information communicated to the UE 1115 in the second cell group. For example, communicating component 1140 can receive the indication from one or more cells in the second cell group (e.g., network entity 1105-b), as described, from UE 1115, and/or the like. Thus, in an example, method 1200 may include, at Block 1218, generating the first antenna selection information based on the second antenna selection information. Information generating component 1150 may generate the first antenna selection information based on the second antenna selection information.

FIG. 13 illustrates an example method 1300 for coordinating antenna selection information for a UE among a plurality of network entities, in accordance with various aspects of the present disclosure. Method 1300 includes, at Block 1310, communicating with a UE in a first cell group. In an aspect, communicating component 1140, e.g., in conjunction with processor(s) 1103, memory 1104, and/or transceiver 1109, can communicate with the UE 1115 in the first cell group (e.g., an MCG or SCG). For example, communicating component 1140 can communicate with the UE 1115 over at least a first carrier of communication link 1125-a. Moreover, network entity 1105-a may configure the UE 1115 to communicate with additional cells in the cell group, additional cells in other cell groups (e.g., network entity 1105-b), etc., in multiple connectivity.

Method 1300 may also include, at Block 1312, receiving an indication of antenna selection information communicated to the UE in a second cell group. For example, communicating component 1140, e.g., in conjunction with processor(s) 1103, memory 1104, and/or transceiver 1109, can receive the indication of the antenna selection information communicated to the UE 1115 in the second cell group. For example, communicating component 1140 can receive the indication from one or more cells in the second cell group (e.g., network entity 1105-b), as described, from UE 1115, and/or the like. The indication of the antenna selection information may include, for example, an action time or configured modification period for each possible antenna selection change in the second cell group (e.g., a specific system time, antenna port, etc.).

Method 1300 may also include, at Block 1314, determining to expect antenna selection by the UE based on the antenna selection information. In an aspect, communicating component 1140, e.g., in conjunction with processor(s) 1103, memory 1104, and/or transceiver 1109, may accordingly determine to expect antenna selection by the UE 1115 (e.g., to another port) based on the antenna selection information, and may accordingly receive uplink transmissions from the UE 1115 based on the antenna selection information related to the second cell group (e.g., at or during a time interval specified in the antenna selection information).

In another example, method 1300 may include, at Block 1316, refraining from scheduling uplink transmissions for the UE in the first cell group during a time interval indicated in the second antenna selection information. In an aspect, communicating component 1140, e.g., in conjunction with processor(s) 1103, memory 1104, and/or transceiver 1109, can refrain from scheduling the uplink transmission for the UE 1115 in the first cell group during the time interval indicated in the second antenna selection information. For example, this can include communicating component 1140 scheduling or otherwise having an idle period for the UE 1115 for the first cell group during the same or an overlapping time interval as that indicated in the second antenna selection information. This can be performed by coordination among the network entities 1105-a and 1105-b. For example, network entity 1105-b of the second cell group may indicate to network entity 1105-a of the first cell group (e.g., over backhaul link 1134) that the antenna selection is to occur at a specific time (which may be indicated in antenna selection information to the UE 1115 as well), and the network entity 1105-a may not schedule uplink transmission for the UE 1115 in the same or overlapping time interval. Thus, in this example, the UE 1115 can perform antenna selection during the time interval based on the antenna selection information for the second cell group without disturbing transmissions in the first cell group.

An example is depicted in FIG. 8, as described previously, which illustrates example asynchronous timelines 800 of subframes for multiple cell groups. For example, a timeline for the second cell group can include subframes 802, 804, 806 which are offset in time from a timeline for the first cell group including subframes 812, 814. In this example, antenna selection information can be communicated from the first cell group for subframe 814, which overlaps subframes 804 and 806 for the second cell group. Accordingly, communicating component 1140 may provide an idle period for the UE 1115 with respect to the second cell group in subframe 804 to avoid the UE 1115 transmitting uplink communications to the network entity 1105-b based on the new antenna selection.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but it is to be accorded the widest scope consistent with the principles and novel features disclosed herein.

What is claimed is:

1. A method for selecting one or more antenna ports for wireless communications, comprising:
establishing a first communication link over at least a first carrier with at least a first cell of a first cell group;
establishing a second communication link over at least a second carrier with at least a second cell of a second cell group;
receiving first antenna selection information from the at least first cell of the first cell group, wherein the first antenna selection information relates to a first interval during which to select a first antenna; and
determining, based at least in part on the first antenna selection information, a second antenna to utilize in communicating over the second communication link during the first interval.

2. The method of claim 1, wherein the first cell group is a primary cell group and the second cell group is a secondary cell group in multiple connectivity.

3. The method of claim 1, wherein determining the second antenna is based at least in part on a configured priority for antenna selection information from the first cell group over the second cell group.

4. The method of claim 1, wherein the first cell group and the second cell group are synchronous in time.

5. The method of claim 4, further comprising determining the second antenna is the same as the first antenna during the first interval.

6. The method of claim 1, wherein the first cell group and the second cell group are asynchronous in time.

7. The method of claim 6, further comprising receiving second antenna selection information from the at least second cell of the second cell group, wherein the second antenna selection information relates to a second interval during which to select the second antenna, and wherein the second interval at least partially overlaps the first interval.

8. The method of claim 7, further comprising determining whether to communicate over the second communication link during the second interval based at least in part on receiving the first antenna selection information and receiving the second antenna selection information.

9. The method of claim 6, further comprising receiving second antenna selection information from the at least first cell of the first cell group, wherein the second antenna selection information relates to a second interval during which to select a third antenna, and wherein the second interval is different from the first interval.

10. The method of claim 9, further comprising determining whether to communicate over the second communication link during the second interval, which overlaps the first interval and the third interval, based at least in part on receiving the first antenna selection information and receiving the second antenna selection information.

11. The method of claim 9, further comprising dropping a transmission scheduled over the second communication link based at least in part on determining that one or more antenna ports indicated in the first antenna selection information differ from a different one or more antenna ports indicated in the second antenna selection information.

12. The method of claim 1, further comprising communicating a capability indicator to at least one of the at least first cell or the at least second cell.

13. The method of claim 12, wherein the capability indicator indicates support of communicating with multiple cells using multiple antenna port configurations, and wherein determining the second antenna comprises determining the second antenna as different from the first antenna.

14. The method of claim 12, wherein the capability indicator indicates no support of communicating with multiple cells using multiple antenna port configurations, and further comprising disabling a closed loop antenna selection.

15. An apparatus for selecting one or more antenna ports for wireless communications, comprising:
a transceiver;
at least one processor communicatively coupled with the transceiver, via a bus, for communicating signals in a wireless network; and
a memory communicatively coupled with the at least one processor and/or the transceiver via the bus;
wherein the at least one processor is operable to:
establish a first communication link over at least a first carrier with at least a first cell of a first cell group;
establish a second communication link over at least a second carrier with at least a second cell of a second cell group;
receive first antenna selection information from the at least first cell of the first cell group, wherein the first antenna selection information relates to a first interval during which to select a first antenna; and
determine, based at least in part on the first antenna selection information, a second antenna to utilize in communicating over the second communication link during the first interval.

16. The apparatus of claim 15, wherein the first cell group is a primary cell group and the second cell group is a secondary cell group in multiple connectivity.

17. The apparatus of claim 15, wherein the at least one processor is operable to determine the second antenna based at least in part on a configured priority for antenna selection information from the first cell group over the second cell group.

18. The apparatus of claim 15, wherein the first cell group and the second cell group are synchronous in time.

19. The apparatus of claim 18, wherein the at least one processor is further operable to determine the second antenna is the same as the first antenna during the first interval.

20. The apparatus of claim 15, wherein the first cell group and the second cell group are asynchronous in time.

21. The apparatus of claim 20, wherein the at least one processor is further operable to receive second antenna selection information from the at least second cell of the second cell group, wherein the second antenna selection information relates to a second interval during which to select the second antenna, and wherein the second interval at least partially overlaps the first interval.

22. The apparatus of claim 21, wherein the at least one processor is further operable to determine whether to communicate over the second communication link during the second interval based at least in part on receiving the first antenna selection information and receiving the second antenna selection information.

23. The apparatus of claim 20, wherein the at least one processor is further operable to receive second antenna selection information from the at least first cell of the first cell group, wherein the second antenna selection information relates to a second interval during which to select a third antenna, and wherein the second interval is different from the first interval.

24. The apparatus of claim 23, wherein the at least one processor is operable to determine whether to communicate over the second communication link during the second interval, which overlaps the first interval and the third interval, based at least in part on receiving the first antenna selection information and receiving the second antenna selection information.

25. The apparatus of claim 23, wherein the at least one processor is further operable to drop a transmission scheduled over the second communication link based at least in part on determining that one or more antenna ports indicated in the first antenna selection information differ from a different one or more antenna ports indicated in the second antenna selection information.

26. The apparatus of claim 15, wherein the at least one processor is further operable to communicate a capability indicator to at least one of the at least first cell or the at least second cell.

27. The apparatus of claim 26, wherein the capability indicator indicates support of communicating with multiple cells using multiple antenna port configurations, and wherein the at least one processor is operable to determine the second antenna at least in part by determining the second antenna as different from the first antenna.

28. The apparatus of claim 26, wherein the capability indicator indicates no support of communicating with multiple cells using multiple antenna port configurations, and wherein the at least one processor is further operable to disable a closed loop antenna selection.

29. An apparatus for selecting one or more antenna ports for wireless communications, comprising:
means for establishing a first communication link over at least a first carrier with at least a first cell of a first cell group;
means for establishing a second communication link over at least a second carrier with at least a second cell of a second cell group;
means for receiving first antenna selection information from the at least first cell of the first cell group, wherein the first antenna selection information relates to a first interval during which to select a first antenna; and
means for determining, based at least in part on the first antenna selection information, a second antenna to utilize in communicating over the second communication link during the first interval.

30. A computer-readable storage medium comprising computer-executable code for selecting one or more antenna ports for wireless communications, the code comprising:
code for establishing a first communication link over at least a first carrier with at least a first cell of a first cell group;
code for establishing a second communication link over at least a second carrier with at least a second cell of a second cell group;
code for receiving first antenna selection information from the at least first cell of the first cell group, wherein the first antenna selection information relates to a first interval during which to select a first antenna; and
code for determining, based at least in part on the first antenna selection information, a second antenna to utilize in communicating over the second communication link during the first interval.
